(19) United States
(12) Patent Application Publication
(10) Pub. No.: US 2026/0250188 A1
(43) Pub. Date: Aug. 27, 2026

(54) DEVICES FOR MATING GLASS SLIDES

(71) Applicant: Singular Genomics Systems, Inc., San Diego, CA (US)

(72) Inventors: Kevin MARSHALL, Poway, CA (US); Matthew KETTERER, Scottsdale, AZ (US)

(21) Appl. No.: 19/644,981

(22) Filed: Apr. 10, 2026

Related U.S. Application Data
(63) Continuation of application No. PCT/US25/54191, filed on Nov. 5, 2025.
(60) Provisional application No. 63/717,602, filed on Nov. 7, 2024.
(60) Provisional application No. 63/728,462, filed on Dec. 5, 2024.
(60) Provisional application No. 63/750,432, filed on Jan. 28, 2025.

(51) Int. Cl. C03C 27/06; B01L 9/00

(52) U.S. Cl. CPC C03C 27/06; B01L 9/52; B01L 2200/025; B01L 2200/087; B01L 2300/021; B01L 2300/043; B01L 2300/0822; B01L 2300/12; B01L 2300/168

(57) ABSTRACT

Disclosed herein, inter alia, are devise and tools useful for joining two glass slides.

### CROSS-REFERENCES TO RELATED APPLICATIONS

This application is a continuation of International Patent Application No. PCT/US2025/054191, filed Nov. 5, 2025, which claims the benefit of U.S. Provisional Application No. 63/750,432, filed Jan. 28, 2025, U.S. Provisional Application No. 63/728,462, filed Dec. 5, 2024, and U.S. Provisional Application No. 63/717,602, filed Nov. 7, 2024, each of which is incorporated herein by reference in their entirety and for all purposes.

### BACKGROUND

In laboratory and diagnostic applications, the formation of a reliable flow cell is critical for conducting controlled biological reactions and imaging processes. A flow cell typically comprises two precisely aligned glass slides: a functionalized planar slide that retains biological specimens and a complementary slide configured to define a reaction channel, complete with ports for the introduction and removal of fluids. Traditional methods for mating these slides, however, pose significant challenges. Misalignment can lead to inconsistent flow dynamics and compromised imaging quality, while improper sealing may result in fluid leaks, jeopardizing sample integrity and experimental outcomes. Furthermore, the fragile nature of glass increases the risk of chipping or breakage during assembly, particularly when high precision (i.e., within a tolerance of 100 microns) is typically required to ensure proper flow cell function. Thus, there is a critical need for a device that can securely mate these two slides, providing active alignment, a foolproof assembly process, and protection against damage, thereby enabling reliable, high-quality flow cell formation for a wide range of scientific and diagnostic applications. Disclosed herein, inter alia, are solutions to these and other problems in the art.

### BRIEF SUMMARY

In an aspect is provided a slide mating assembly. In embodiments, the slide mating assembly includes a first glass slide section having an upper surface size and shaped to receive a first glass slide; a second slide section having an upper surface size and shaped to receive a second slide; a hinge assembly that movably couples the first glass slide section to the second slide section such that the slide mating assembly can transition between an open state and a closed state, wherein the upper surface of the first glass slide section is in juxtaposed contact with the upper surface of the second slide section; and at least one lock assembly configured to lock the slide mating assembly in the open state or the closed state. In embodiments, the first glass slide is a drilled glass slide (e.g., including one or more input and output ports). In embodiments, the second glass slide is a tissue slide (e.g., designated to receive a tissue sample). In embodiments the first glass slide includes one or more channels. In embodiments, the first glass slide includes a gasket which is configured to define one or more channels. In embodiments, the first glass slide includes an adhesive.

### BRIEF DESCRIPTION OF THE DRAWINGS

FIGS. 1A-1F. 1A and 1B show a slide mating assembly or a slide assembly fixture 105 includes a drilled glass slide section 110 and a Tissue Slide section 115 that are movably coupled to one another via a hinge assembly 125. The hinge assembly 125 rotatably attaches the drilled glass slide section 110 and a tissue slide section 115 such that the drilled glass slide section 110 and a tissue slide section 115 can open and close in “clamshell” or folding configuration. The drilled glass slide section 110 has an upper surface 130 that defines a seat sized and shaped to receive a drilled glass slide 135 (FIGS. 1C and 1D) as described further below. The tissue slide section 115 likewise has an upper surface 140 that defines a seat sized and shaped to receive a tissue slide 145 (FIGS. 1C and 1D) as described further below. FIGS. 1C and 1D show the drilled glass slide 135 and tissue slide 145 positioned on the drilled glass slide section 110 and the tissue slide section 115, respectively. The drilled glass slide section 110 and the tissue slide section 115 can each be a prismatic body or structure that has a rectangular shape when viewed from the top although the shape can vary. With reference to FIG. 1B, the drilled glass slide section 110 has a glass slide lock assembly with an actuator, such as a lever 150, that can be actuated to lock the drilled glass slide 135 onto the drilled glass slide section 110. The tissue slide section 115 likewise has a tissue slide lock assembly with an actuator, such as a lever 150, that can be actuated to lock the tissue slide 145 onto the drilled glass slide section 110, as described further herein. To assemble the flow cell, the slide assembly fixture 105 is positioned into the open position as shown in FIG. 1A and FIG. 1B. In the open position or open state, the upper surfaces of the drilled glass slide section 110 and the tissue slide section 115 can both be facing upward and/or can be co-planar. As mentioned, the fixture 105 designates the “Drilled Glass Slide” section 110 on the right and the “Tissue Slide” section 115 on the left. Both sides of the fixture 105 are opened by adjusting the levers 150 and 155 to an open padlock position. With the fixture prepared, the drilled glass slide 130 is inserted into its designated area on the right (“Drilled Glass Slide” section 110), as shown in FIG. 1C and FIG. 1D. A chamfered edge of the drilled slide 130 can be aligned with a pin located in the top right corner (or other location.). The drilled glass slide 135 has top liner that at least temporarily remains on the drilled glass slide 135 to protect the adhesive. Once positioned correctly, the drilled glass slide 135 is secured by moving the lever to a locked padlock setting. Next, tissue slide 145 is placed into the left side of the fixture (the “Tissue Slide” section 115) ensuring that the mounted tissue faces upward. A marker, such as a faintly engraved “F” on the tissue slide can be aligned with a corresponding “F” marking on the fixture 105. After confirming the correct placement, the tissue slide 145 is secured to the “Tissue Slide” section 115 by adjusting the lever 155 to the locked position. FIG. 1F shows the levers 150 and 155 in the locked position. FIG. 1E shows the slide assembly fixture 105 in the closed state. The drilled glass slide aligns in juxtaposition with the tissue slide when the fixture is closed.

FIGS. 2A-2B. The slide mating assembly with the latches 150 and 155 are engaged (FIG. 2A). To release the assembly, the lever 150 on the drilled glass side 110 is moved to the open padlock position, as shown in FIG. 2B, allowing the fixture to unlock.

FIGS. 3A-3B. The associated mechanism for locking via the levers 150 and 155 is shown in FIGS. 3A and 3B.

FIG. 4 shows the slide assembly fixture 105 in the closed state.

FIGS. 5A and 5B shows a glass slide mating assembly (or a slide assembly fixture 105) which includes a Drilled Glass Slide section 110 and a Tissue Slide section 115 that are movably coupled to one another via a hinge assembly 125. Set screws 125a and 125b allow for Y-axis adjustment and rotation around Z-axis permitted by hinge flexure designed into the “Drilled Slide” hinges. The spring 129a and shim 129b enable x-axis adjustment and refining. The hinge assembly 125 rotatably attaches the drilled glass slide section 110 and a tissue slide section 115 such that the drilled glass slide section 110 and a tissue slide section 115 can open and close in “clamshell” or folding configuration. The drilled glass slide section 110 has an upper surface 130 that defines a seat sized and shaped to receive a drilled glass slide 135. One or more depressions 128 are included in the surface to facilitate placement and removal of the glass slide. The tissue slide section 115 likewise has an upper surface 140 that defines a seat sized and shaped to receive a tissue slide 145 as described herein. The drilled glass slide aligns in juxtaposition with the tissue slide when the fixture is closed. Independent clamp pins, for example the x-clamp pin 126 and the y-clamp pin 127 are included to aid in slide alignment. FIG. 5B illustrates the hinge flexure geometry.

FIGS. 6A and 6B shows the locking mechanism with insets to show the gap (e.g., 1 mm gap) between sliders 165 and cams 160 when in the locked position creates a controlled magnetic spring force that pulls the slider against the glass slide. Magnets are embedded in the sliders 165 which are associated with the x-clamp pin 126 and the y-clamp pin 127 to secure and retain the slide.

FIG. 7 show a slide mating assembly or a slide assembly fixture with additional embodiments. For example, illustrated in FIG. 7 is the slide mating assembly including a finger well (705) configured for aiding in inserting and removing the planar glass slide. Additionally, one or more grooves or moats (710) exist for dispelling excess liquid or debris. In embodiments, one or both of the surfaces include a marking or indentation (715) aiding in orienting the slide onto the assembly. To prevent accidental unlocking and potential premature release of the glass slide an unlock blocking element (720) may be included which extends from the assembly to retain the locking lever. Also depicted in the assembly is a base pad (725) extending outwardly from the tissue slide section, wherein the pad positioned so that a user can place a finger on the pad to secure a position of the tissue slide section on a flat surface. In embodiments, the assembly includes an upraised corner exclusion pad (730) on the upper surface of the tissue slide section, wherein the corner exclusion pad is configured to properly position a chamfered corner of tissue slide on the upper surface of the tissue slide section. In embodiments, the assembly includes a handle (735) on the drilled glass slide section, the handle having a rotatable portion that rotates as the slide mating assembly transitions between the open state and the closed state. In embodiments, the assembly includes a tactile pad (740) on an outer surface of the tissue slide section or the drilled glass slide section, the tactile pad configured to secure a position of the slide mating assembly when in contact with a flat surface (e.g., a benchtop).

FIG. 8 depicts the assembly in the closed state.

FIG. 9 shows an embodiment of the assembly device from the underside. In embodiments, the assembly device includes an enlarged extension portion (745) configured to interact with the hinge assembly to prevent the slide mating assembly from opening beyond 180 degrees.

### DETAILED DESCRIPTION

The aspects and embodiments described herein relate to a device useful for joining two independent glass slides to form a flow cell.

### I. Definitions

All patents, patent applications, articles and publications mentioned herein, both supra and infra, are hereby expressly incorporated herein by reference in their entireties.

Unless defined otherwise herein, all technical and scientific terms used herein have the same meaning as commonly understood by one of ordinary skill in the art to which this disclosure belongs. Various scientific dictionaries that include the terms included herein are well known and available to those in the art. Although any methods and materials similar or equivalent to those described herein find use in the practice or testing of the disclosure, some preferred methods and materials are described. Accordingly, the terms defined immediately below are more fully described by reference to the specification as a whole. It is to be understood that this disclosure is not limited to the particular methodology, protocols, and reagents described, as these may vary, depending upon the context in which they are used by those of skill in the art. The following definitions are provided to facilitate understanding of certain terms used frequently herein and are not meant to limit the scope of the present disclosure.

As used herein, the singular terms “a”, “an”, and “the” include the plural reference unless the context clearly indicates otherwise. Reference throughout this specification to, for example, “one embodiment”, “an embodiment”, “another embodiment”, “a particular embodiment”, “a related embodiment”, “a certain embodiment”, “an additional embodiment”, or “a further embodiment” or combinations thereof means that a particular feature, structure or characteristic described in connection with the embodiment is included in at least one embodiment of the present disclosure. Thus, the appearances of the foregoing phrases in various places throughout this specification are not necessarily all referring to the same embodiment. Furthermore, the particular features, structures, or characteristics may be combined in any suitable manner in one or more embodiments.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

As used herein, the term “about” means a range of values including the specified value, which a person of ordinary skill in the art would consider reasonably similar to the specified value. In embodiments, the term “about” means within a standard deviation using measurements generally acceptable in the art. In embodiments, about means a range extending to +/−10% of the specified value. In embodiments, about means the specified value.

Throughout this specification, unless the context requires otherwise, the words “comprise”, “comprises” and “comprising” will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that no other elements are optional and may or may not be present depending upon whether or not they affect the activity or action of the listed elements.

In the description, relative terms such as “before,” “after,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing or figure under discussion. These relative terms are for convenience of description and do not require that the system be constructed or operated in a particular orientation.

As used herein, the term “contacting” is used in accordance with its plain ordinary meaning and refers to the process of allowing at least two distinct species (e.g., chemical compounds, biomolecules, nucleotides, binding reagents, or cells) to become sufficiently proximal to react, interact or physically touch. However, the resulting reaction product can be produced directly from a reaction between the added reagents or from an intermediate from one or more of the added reagents that can be produced in the reaction mixture. The term “contacting” may include allowing two species to react, interact, or physically touch, wherein the two species may be a compound, a protein (e.g., an antibody), substrate, device, or enzyme.

A “functionalized” solid support, as used herein, may refer to the post hoc conjugation of a moiety to a functional group on the surface of a solid support.

As used herein, the term “polymer” refers to macromolecules having one or more structurally unique repeating units. The repeating units are referred to as “monomers,” which are polymerized for the polymer. Typically, a polymer is formed by monomers linked in a chain-like structure. A polymer formed entirely from a single type of monomer is referred to as a “homopolymer.” A polymer formed from two or more unique repeating structural units may be referred to as a “copolymer.” A polymer may be linear or branched, and may be random, block, polymer brush, hyperbranched polymer, bottlebrush polymer, dendritic polymer, or polymer micelles. The term “polymer” includes homopolymers, copolymers, tripolymers, tetra polymers and other polymeric molecules made from monomeric subunits. Copolymers include alternating copolymers, periodic copolymers, statistical copolymers, random copolymers, block copolymers, linear copolymers and branched copolymers. The term “polymerizable monomer” is used in accordance with its meaning in the art of polymer chemistry and refers to a compound that may covalently bind chemically to other monomer molecules (such as other polymerizable monomers that are the same or different) to form a polymer.

Polymers can be hydrophilic, hydrophobic or amphiphilic, as known in the art. Thus, “hydrophilic polymers” are substantially miscible with water and include, but are not limited to, polyethylene glycol and the like. “Hydrophobic polymers” are substantially immiscible with water and include, but are not limited to, polyethylene, polypropylene, polybutadiene, polystyrene, polymers disclosed herein, and the like. “Amphiphilic polymers” have both hydrophilic and hydrophobic properties and are typically copolymers having hydrophilic segment(s) and hydrophobic segment(s). Polymers include homopolymers, random copolymers, and block copolymers, as known in the art. The term “homopolymer” refers, in the usual and customary sense, to a polymer having a single monomeric unit. The term “copolymer” refers to a polymer derived from two or more monomeric species. The term “random copolymer” refers to a polymer derived from two or more monomeric species with no preferred ordering of the monomeric species. The term “block copolymer” refers to polymers having two or homopolymer subunits linked by covalent bond. Thus, the term “hydrophobic homopolymer” refers to a homopolymer which is hydrophobic. The term “hydrophobic block copolymer” refers to two or more homopolymer subunits linked by covalent bonds and which is hydrophobic.

As used herein, the term “hydrogel” refers to a three-dimensional polymeric structure that is substantially insoluble in water, but which is capable of absorbing and retaining large quantities of water to form a substantially stable, often soft and pliable, structure. In embodiments, water can penetrate in between polymer chains of a polymer network, subsequently causing swelling and the formation of a hydrogel. In embodiments, hydrogels are super-absorbent (e.g., containing more than about 90% water) and can include natural or synthetic polymers. In some embodiments, the hydrogel polymer includes 60-90% fluid, such as water, and 10-30% polymer. In certain embodiments, the water content of hydrogel is about 70-80%.

Hydrogels may be prepared by cross-linking hydrophilic biopolymers or synthetic polymers. Thus, in some embodiments, the hydrogel may include a crosslinker. As used herein, the term “crosslinker” refers to a molecule that can form a three-dimensional network when reacted with the appropriate base monomers. Examples of the hydrogel polymers, which may include one or more crosslinkers, include but are not limited to, hyaluronans, chitosans, agar, heparin, sulfate, cellulose, alginates (including alginate sulfate), collagen, dextrans (including dextran sulfate), pectin, carrageenan, polylysine, gelatins (including gelatin type A), agarose, (meth)acrylate-oligolactide-PEO-oligolactide-(meth)acrylate, PEO—PPO-PEO copolymers (Pluronics), poly(phosphazene), poly(methacrylates), poly(N-vinylpyrrolidone), PL(G)A-PEO-PL(G)A copolymers, poly(ethylene imine), polyethylene glycol (PEG)-thiol, PEG-acrylate, acrylamide, N, N′-bis(acryloyl)cystamine, PEG, polypropylene oxide (PPO), polyacrylic acid, poly(hydroxyethyl methacrylate) (PHEMA), poly(methyl methacrylate) (PMMA), poly(N-isopropylacrylamide) (PNIPAAm), poly(lactic acid) (PLA), poly(lactic-co-glycolic acid) (PLGA), polycaprolactone (PCL), poly(vinylsulfonic acid) (PVSA), poly(L-aspartic acid), poly(L-glutamic acid), bisacrylamide, diacrylate, diallylamine, triallylamine, divinyl sulfone, diethyleneglycol diallyl ether, ethyleneglycol diacrylate, polymethyleneglycol diacrylate, polyethyleneglycol diacrylate, trimethylopropoane trimethacrylate, ethoxylated trimethylol triacrylate, or ethoxylated pentaerythritol tetracrylate, or combinations thereof. Thus, for example, a combination may include a polymer and a crosslinker, for example polyethylene glycol (PEG)-thiol/PEG-acrylate, acrylamide/N, N′-bis(acryloyl)cystamine (BACy), or PEG/polypropylene oxide (PPO).

As used herein, the term “infrared (IR) reflective coating” refers to a material deposited onto a solid support capable of reflecting some or all infrared light. The effectiveness of an IR reflective coating is noted in its capability to reflect light that falls within the infrared spectrum, specifically light with wavelengths ranging from about 750 nanometers (nm) to about 1,000 micrometers (μm). Examples of IR reflective coating include, but are not limited to, metal oxides and silver. In embodiments, the infrared (IR) reflective coatings may include materials such as gold, aluminum, tantalum oxide, chromium, zinc sulfide, and titanium dioxide. Gold is known for its excellent reflectivity, particularly in the near-infrared range; aluminum is a lightweight metal with a natural oxide layer that enhances its IR reflectivity; chromium, a metal noted for its durable and reflective characteristics, zinc sulfide, a compound frequently used in optical components due to its transparency and reflectivity in the infrared range, and titanium dioxide, a compound widely used for its high refractive index and strong IR reflective properties, are exemplary of the diverse range of materials that can be employed as IR reflective coatings. In embodiments, the infrared (IR) reflective coating includes one or more layers of silicon dioxide (SiO₂) and tantalum pentoxide (Ta₂O₅). The IR reflective coating may reflect a portion of the total radiation. In embodiments, the IR reflective coating aids autofocus mechanisms in optical instruments (e.g., fluorescence microscopy instruments) to provide consistent signal across various z-heights (e.g., the depth of an image). In embodiments, the IR reflective coating increases the amount of light reflected to the autofocus sensor to provide consistent signal across various z-heights. In embodiments, the IR reflective coating improves the signal to noise ratio of an image acquired by an optical instrument.

As used herein, the term “interfacial”, or “interfacial layer”, is used in accordance with its plain ordinary meaning and refers to the boundary between any two bulk phases (gas, liquid, or solid) in contact where the properties differ from the properties of the bulk phases. In embodiments, an interfacial layer includes water. Interfacial water differs from bulk water in a number of properties, for example, interfacial water has a higher heat capacity than bulk water because more energy is necessary to break its hydrogen bonds. The arrangement and structure of the interfacial water layer varies depending on the structure of the hydrophilic and/or hydrophobic surface(s) the water layer is in contact with. Additional properties of interfacial water may be found in, e.g., Mentre P. J. Biol. Phys. and Chem. 2004; 4:115-123 and Tanaka M. Front. Chem. 2020; 8:165, which are incorporated herein by reference in their entirety.

As used herein, the terms “solid support” and “substrate” and “substrate surface” and “solid surface” refers to discrete solid or semi-solid substrate. In embodiments, a plurality of functional groups (e.g., bioconjugate reactive moieties or specific binding reagents) may be attached to the substrate. A solid support may encompass any type of solid, porous, or hollow sphere, ball, cylinder, or other similar configuration composed of plastic, ceramic, metal, or polymeric material (e.g., hydrogel) onto which a nucleic acid or tissue may be immobilized (e.g., covalently or non-covalently). A solid support may include a discrete particle that may be spherical (e.g., microspheres) or have a non-spherical or irregular shape, such as cubic, cuboid, pyramidal, cylindrical, conical, oblong, or disc-shaped, and the like. A bead can be non-spherical in shape. A solid support may be used interchangeably with the term “bead.” A solid support may further include a polymer or hydrogel on the surface to which the primers are attached. Exemplary solid supports include, but are not limited to, glass and modified or functionalized glass, plastics (including acrylics, polystyrene and copolymers of styrene and other materials, polypropylene, polyethylene, polybutylene, polyurethanes, Teflon™, cyclic olefin copolymers, polyimides etc.), nylon, ceramics, resins, Zeonor®, silica or silica-based materials including silicon and modified silicon, carbon, metals, inorganic glasses, optical fiber bundles, photopatternable dry film resists, UV-cured adhesives and polymers. Particularly useful solid supports for some embodiments have at least one surface located on a microplate. Particularly useful solid supports for some embodiments have at least one surface located on a microplate within a flow cell. Solid surfaces can also be varied in their shape depending on the application in a method described herein. For example, a solid surface useful herein can be planar, or contain regions which are concave or convex. In embodiments, the geometry of the concave or convex regions (e.g., wells) of the solid surface conform to the size and shape of a substantially circular particle to maximize the contact between the particle. In embodiments, the wells of an array are randomly located such that nearest neighbor wells have random spacing between each other. Alternatively, in embodiments the spacing between the wells can be ordered, for example, forming a regular pattern. The term solid substrate is encompassing of a substrate (e.g., a microplate or flow cell) having a surface including a polymer coating covalently attached thereto.

Broadly speaking, for nucleic acid sequencing applications and spatial biology, a flow cell may be considered a reaction chamber that contains one or more nucleic acid templates, to which nucleotides and ancillary reagents are iteratively applied and washed away. The flow cell allows for imaging of the sites at which the nucleic acids are bound, and resulting image data is used for the desired analysis.

In embodiments, the solid substrate is a flow cell. The term “flow cell” as used herein refers to a chamber including a solid surface across which one or more fluid reagents can be flowed. Examples of flow cells and related fluidic systems and detection platforms that can be readily used in the methods of the present disclosure are described, for example, in Bentley et al., Nature 456:53-59 (2008). In certain embodiments a substrate includes a surface (e.g., a surface of a flow cell, a surface of a tube, a surface of a chip), for example a metal surface (e.g., steel, gold, silver, aluminum, silicon and copper). In embodiments a substrate (e.g., a substrate surface) is coated and/or includes functional groups and/or inert materials. In certain embodiments a substrate includes a bead, a chip, a capillary, a plate, a membrane, a wafer (e.g., silicon wafers), a comb, or a pin for example. In some embodiments a substrate includes a bead and/or a nanoparticle. A substrate can be made of a suitable material, non-limiting examples of which include a plastic or a suitable polymer (e.g., polycarbonate, poly(vinyl alcohol), poly(divinylbenzene), polystyrene, polyamide, polyester, polyvinylidene difluoride (PVDF), polyethylene, polyurethane, polypropylene, and the like), borosilicate, glass, nylon, Wang resin, Merrifield resin, metal (e.g., iron, a metal alloy, sepharose, agarose, polyacrylamide, dextran, cellulose and the like or combinations thereof. In embodiments a substrate includes a magnetic material (e.g., iron, nickel, cobalt, platinum, aluminum, and the like). In embodiments a substrate includes a magnetic bead (e.g., DYNABEADS®, hematite, AMPure XP). Magnets can be used to purify and/or capture nucleic acids bound to certain substrates (e.g., substrates including a metal or magnetic material). The flow cell is typically a glass slide containing small fluidic channels (e.g., a glass slide 75 mm×25 mm×1 mm having one or more channels), through which sequencing solutions (e.g., polymerases, nucleotides, and buffers) may traverse. Though typically glass, suitable flow cell materials may include polymeric materials, plastics, silicon, quartz (fused silica), Borofloat® glass, silica, silica-based materials, carbon, metals, an optical fiber or optical fiber bundles, sapphire, or plastic materials such as COCs and epoxies. The particular material can be selected based on properties desired for a particular use. For example, materials that are transparent to a desired wavelength of radiation are useful for analytical techniques that will utilize radiation of the desired wavelength. Conversely, it may be desirable to select a material that does not pass radiation of a certain wavelength (e.g., being opaque, absorptive, or reflective). In embodiments, the material of the flow cell is selected due to the ability to conduct thermal energy. In embodiments, a flow cell includes inlet and outlet ports and a flow channel extending there between. In embodiments, the term “flow cell” refers to a vessel having a chamber (e.g., a flow channel or “lane”) where a reaction can be carried out, an inlet for delivering reagent(s) to the chamber, and an outlet for removing reagent(s) from the chamber.

As used herein, the term “channel” refers to a passage in or on a substrate material that directs the flow of a fluid. A channel may run along the surface of a substrate, or may run through the substrate between openings in the substrate. A channel can have a cross section that is partially or fully surrounded by substrate material (e.g., a fluid impermeable substrate material). For example, a partially surrounded cross section can be a groove, trough, furrow or gutter that inhibits lateral flow of a fluid. The transverse cross section of an open channel can be, for example, U-shaped, V-shaped, curved, angular, polygonal, or hyperbolic. A channel can have a fully surrounded cross section such as a tunnel, tube, or pipe. A fully surrounded channel can have a rounded, circular, elliptical, square, rectangular, or polygonal cross section. In particular embodiments, a channel can be located in a flow cell, for example, being embedded within the flow cell. A channel in a flow cell can include one or more windows that are transparent to light in a particular region of the wavelength spectrum. In embodiments, the channel contains one or more polymers of the disclosure. In embodiments, the channel is filled by the one or more polymers, and flow through the channel (e.g., as in a sample fluid) is directed through the polymer in the channel. In embodiments, the tissue is in a channel of a flow cell.

As used herein, the term “gasket” refers to an element that separates the first solid support and the second solid support to define a reaction chamber on the second solid support, wherein the reaction chamber includes a defined gap or channel through which liquid can flow or be contained. In embodiments, a gasket is a spacer element. In embodiments, the thickness (also referred herein as the “depth” or “height” of the channel) may be altered by modulating the height of the gasket or spacer element. In embodiments, the gasket or spacer element includes a peel-off backing designed to form a sealed reaction chamber on the second solid support when adhered to the first solid support. This design ensures the creation of defined channels necessary for fluid flow and biochemical reactions within the assembled flow cell (e.g., flow cell assembly described herein). An example of a gasket or spacer element includes, but is not limited to, those used in the NovaSeq™6000 S4 flow cells, commercialized by Illumina®, which is depicted in Poovathingal et al. (doi: 10.1101/2024.02.22.581576).

As used herein, the term “reaction chamber” refers to a contained space or vessel designed for conducting chemical, biological, or physical reactions. A reaction chamber may include features such as inlets and outlets for introducing and removing substances, sensors for monitoring reaction conditions, and mechanisms for agitation or mixing. In embodiments, the reaction chamber is a part of the flow cell where the cell or tissue is in contact with the fluids (e.g., buffers), polymerases, nucleotides, and reagents used for the methods described herein. In embodiments, the reaction chamber is formed when a first solid support and a second solid support configured to provide a channel are attached together. In embodiments, the reaction chamber is an enclosed (i.e., closed) container containing one or two openings for introducing and removing fluids and reagents.

The term “surface” is intended to mean an external part or external layer of a substrate. The surface can be in contact with another material such as a gas, liquid, gel, polymer, organic polymer, second surface of a similar or different material, metal, or coat. The surface, or regions thereof, can be substantially flat. The substrate and/or the surface can have surface features such as wells, pits, channels, ridges, raised regions, pegs, posts or the like.

As used herein, the term “feature” refers a point or area in a pattern that can be distinguished from other points or areas according to its relative location. An individual feature can include one or more polynucleotides. For example, a feature can include a single target nucleic acid molecule having a particular sequence or a feature can include several nucleic acid molecules having the same sequence (and/or complementary sequence, thereof). Different molecules that are at different features of a pattern can be differentiated from each other according to the locations of the features in the pattern. Non-limiting examples of features include wells in a substrate, particles (e.g., beads) in or on a substrate, polymers in or on a substrate, projections from a substrate, ridges on a substrate, or channels in a substrate. In embodiments, the one or more features include a reaction chamber and its contents. In embodiments, the one or more features includes a target (e.g., a nucleic acid, protein, or biomarker), a cell, or a tissue sample. In embodiments, the feature is a nucleotide (e.g., a fluorescently labeled nucleotide). In embodiments, the feature is a nucleic acid. In embodiments, the feature is a protein. In embodiments, the feature is a biomolecule.

As used herein, the terms “sequencing”, “sequence determination”, and “determining a nucleotide sequence”, are used in accordance with their ordinary meaning in the art, and refer to determination of partial as well as full sequence information of the nucleic acid being sequenced, and particular physical processes for generating such sequence information. That is, the term includes sequence comparisons, fingerprinting, and like levels of information about a target nucleic acid, as well as the express identification and ordering of nucleotides in a target nucleic acid. The term also includes the determination of the identification, ordering, and locations of one, two, or three of the four types of nucleotides within a target nucleic acid. As used herein, the term “sequencing cycle” is used in accordance with its plain and ordinary meaning and refers to incorporating one or more nucleotides (e.g., nucleotide analogues) to the 3′ end of a polynucleotide with a polymerase, and detecting one or more labels that identify the one or more nucleotides incorporated. In embodiments, one nucleotide (e.g., a modified nucleotide) is incorporated per sequencing cycle. The sequencing may be accomplished by, for example, sequencing by synthesis, pyrosequencing, and the like. In embodiments, a sequencing cycle includes extending a complementary polynucleotide by incorporating a first nucleotide using a polymerase, wherein the polynucleotide is hybridized to a template nucleic acid, detecting the first nucleotide, and identifying the first nucleotide. In embodiments, to begin a sequencing cycle, one or more differently labeled nucleotides and a DNA polymerase can be introduced. Following nucleotide addition, signals produced (e.g., via excitation and emission of a detectable label) can be detected to determine the identity of the incorporated nucleotide (based on the labels on the nucleotides). Reagents can then be added to remove the 3′ reversible terminator and to remove labels from each incorporated base. Reagents, enzymes, and other substances can be removed between steps by washing. Cycles may include repeating these steps, and the sequence of each cluster is read over the multiple repetitions.

The terms “bind” and “bound” as used herein are used in accordance with their plain and ordinary meanings and refer to an association between atoms or molecules. The association can be direct or indirect. For example, bound atoms or molecules may be directly bound to one another, e.g., by a covalent bond or non-covalent bond (e.g. electrostatic interactions (e.g. ionic bond, hydrogen bond, halogen bond), van der Waals interactions (e.g. dipole-dipole, dipole-induced dipole, London dispersion), ring stacking (pi effects), hydrophobic interactions and the like). As a further example, two molecules may be bound indirectly to one another by way of direct binding to one or more intermediate molecules (e.g., as in a substrate, bound to a first antibody, bound to an analyte, bound to a second antibody), thereby forming a complex. As used herein, the term “attached” refers to the state of two things being joined, fastened, adhered, connected or bound to each other. For example, a sample such as a cell or tissue, can be attached to a material, such as a hydrogel, polymer, or solid support, by a covalent or non-covalent bond. In embodiments, attachment is a covalent attachment.

As used herein, the term “tissue” is used in accordance with its plain and ordinary meaning and refers to an organization of cells in a structure, where the structure generally functions as a unit in an organism (e.g., mammals) and may carry out specific functions. In some examples, cells in a tissue are configured in a mass and may not be free from one another. This disclosure describes methods of obtaining single biological samples (e.g., cells or nuclei) from tissues that can be used in various single biological samples (e.g., single-cell/nucleus) workflows. In some examples, blood cells (e.g., lymphocytes) can be considered a tissue. However, blood cells, like lymphocytes, generally are free from one another in the blood. The methods disclosed herein can be used to process those cells to obtain cells and/or nuclei, although dissociation steps may not be necessary when using those types of tissues. Generally, any type of tissue can be used in the methods described herein. Examples of tissues that may be used in the disclosed methods include, but are not limited to connective, epithelial, muscle and nervous tissue. In some examples, the tissues are from mammals. Tissues that contain any type of cells may be used. For example, tissues from abdomen, bladder, brain, esophagus, heart, intestine, kidney, liver, lung, lymph node, olfactory bulb, ovary, pancreas, skin, spleen, stomach, testicle, and the like. The tissue may be normal or tumor tissue (e.g., malignant). This example is not meant to be limiting. Although the conditions used in the disclosed may not be identical for different types of tissue, the methods may be applied to any tissue. The tissues used in the disclosed methods may be in various states. In some examples, the tissues used in the disclosed methods may be fresh, frozen, or fixed.

The term “image” is used according to its ordinary meaning and refers to a representation of all or part of an object. The representation may be an optically detected reproduction. For example, an image can be obtained from fluorescent, luminescent, scatter, or absorption signals. The part of the object that is present in an image can be the surface or other xy plane of the object. Typically, an image is a 2 dimensional representation of a 3 dimensional object. An image may include signals at differing intensities (i.e., signal levels). An image can be provided in a computer readable format or medium. An image is derived from the collection of focus points of light rays coming from an object (e.g., the sample), which may be detected by any image sensor.

The term “adhesion strength” or “attachment strength” as used herein refers to the interfacial force bonding two materials together. The adhesion strength may refer to the minimal amount of force necessary to detach and/or remove the two materials. Means for quantifying adhesion strength are known in the art, for example with a pull-off adhesion test. A pull-off adhesion test measures the resistance of a substance (e.g., a tissue sample) from a substrate (e.g., a carrier substrate) when a perpendicular tensile force is applied to the substance. As outlined in the American Society for Testing and Materials (ASTM) D4541 (and similarly in BS EN ISO 4624), the test may include attaching a test dolly to the substance (e.g., the tissue sample) and then pulling the dolly by exerting a force perpendicular to the surface in an effort to remove the dolly with the substance from the substrate. An alternative testing approach is outlined in ASTM D6677 which utilizes a utility knife to peel the substance away from the substrate and ASTM D3359 which uses a pressure sensitive tape. The peel strength tests employed for examining the strength of Band-Aid® bonds is provided in ASTM D903, ASTM D1876, and ASTM F2258, each of which are incorporated herein by reference and may be used for measuring the adhesion strength as described herein. Instruments for performing such measurements include the monotonic uniaxial tensile testing device provided by Bose® Biodynamic Test Instrument, Minnetonka, MN, for example by employing at a constant rate (e.g., 0.05 mm/sec) and continuously recording the load response (e.g., 200 measurements/sec) to the point of macroscopic failure, or the Avery Adhesive Test (AAT).

The term “port” is used in accordance with its plain ordinary meaning and refers to a designated entry or exit point on the device where fluids, gases, or other substances can be introduced into or removed from the microfluidic system. Ports are typically small and precise to accommodate the scaled-down dimensions of microfluidic channels and chambers. For example, the solid support may include an inlet port, that is, a port through which fluids (such as reagents, samples, or solvents) are introduced into the microfluidic device. The solid support may include an outlet port through which fluids exit the microfluidic device. In embodiments, the inlet and outlet ports are distinct and separate. In embodiments, the inlet port and the outlet ports are the same.

As used herein, the term “inlet” or “inlet port” refers to the location on a flow cell assembly where the reagents and fluids used for methods described herein enters the flow cell. As used herein, the term “outlet” or “outlet port” refers to the location on a flow cell assembly where the reagents and fluids used for methods described herein exits the flow cell after contacting the reaction chamber containing the cell or tissue to be analyzed.

The term “platen” is used in accordance with its plain ordinary meaning and refers to a flat platform. The platform composition may include a substantially rigid material, for example, but not limited to, polymers, metals, inorganic oxide materials, such as glasses and sapphire-based materials, and ceramics. In embodiments, the platen includes a surface coating. Numerous surface coatings are possible, such as a polymer thin film, where the polymer may be selected from a range of physical and surface chemistry properties, such as, for example polyhalohydrocarbon, polystyrene, polyamide, polyimide and the like. Alternatively, a surface coating could be an inorganic coating, such as a silicon nitride, silicon carbide, silicon oxide, or diamond. In embodiments, a platen is a substantially planar platform.

The term “align” or “alignment” is used in accordance with its ordinary meaning and refers to perfect alignment and alignment with relatively small, insignificant amount of deviation/misalignment (e.g., ≤5%).

The terms “particle” and “bead” are used interchangeably and mean a small body made of a rigid or semi-rigid material. The body can have a shape characterized, for example, as a sphere, oval, microsphere, or other recognized particle shape whether having regular or irregular dimensions. The term “particle” does not indicate any particular shape. The shapes and sizes of a collection of particles may be different or about the same (e.g., within a desired range of dimensions, or having a desired average or minimum dimension). A particle may be substantially spherical (e.g., microspheres) or have a non-spherical or irregular shape, such as cubic, cuboid, pyramidal, cylindrical, conical, oblong, or disc-shaped, and the like. In embodiments, the particle has the shape of a sphere, cylinder, spherocylinder, or ellipsoid. In embodiments, a particle is a microsphere used as a calibration tool to calibrate and assess the z-axis used in imaging-based methods for in situ spatial sequencing applications. In embodiments, the methods and/or devices described herein include focusing on the beads at different depths to calibrate and image in three dimensions.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

### II. Devices & Assemblies

In an aspect is provided a slide mating assembly. In embodiments, the slide mating assembly includes a first glass slide section having an upper surface size and shaped to receive a first glass slide; a second slide section having an upper surface size and shaped to receive a second slide; a hinge assembly that movably couples the first glass slide section to the second slide section such that the slide mating assembly can transition between an open state and a closed state, wherein the upper surface of the first glass slide section is in juxtaposed contact with the upper surface of the second slide section; and at least one lock assembly configured to lock the slide mating assembly in the open state or the closed state. In embodiments, the first glass slide is a drilled glass slide (e.g., including one or more input and output ports). In embodiments, the second glass slide is a tissue slide (e.g., designated to retain a tissue sample). In embodiments the first glass slide includes one or more channels. In embodiments, the first glass slide includes a gasket which is configured to define one or more channels. In embodiments, the first glass slide includes an adhesive. For example, one slide is affixed onto to the other slide using a pressure sensitive adhesive (PSA) to create a fluidic leak-free seal between the two solid slides. In embodiments, the adhesive is reversible. For example, a reversible adhesive refers to an adhesive that permits the bonded slides to be separated after use without permanent deformation or destruction of the slides. In embodiments, the slides are temporarily affixed during operation to maintain alignment and seal integrity, and may be separated following completion of the assay or processing step. The bond may be disrupted by applying mechanical force, thermal input, or a release agent, resulting in two independent slides that may be retained, inspected, or discarded individually.

In embodiments, the material for the slide mating assembly can be any suitable material, selected based on the intended application and operational requirements. For example, the assembly may be constructed from metals such as steel or aluminum, which provide durability, strength, and resistance to wear. In embodiments, steel may be used for applications requiring high structural integrity and resistance to deformation, while aluminum may be preferred for its lightweight properties and corrosion resistance. In alternative embodiments, the assembly may be fabricated from non-metallic materials, such as high-strength polymers or composites, offering advantages such as chemical resistance, ease of manufacturing, and reduced weight. The choice of material may also consider environmental factors, such as exposure to high temperatures, chemicals, or moisture, to ensure the longevity and reliability of the assembly. In embodiments, the materials for the slide mating assembly may include steel, aluminum, polycarbonate, acrylic, PEEK, nylon, carbon fiber reinforced polymers, glass fiber reinforced polymers, zirconia, alumina, titanium, copper, brass, or silicone rubber. Additional considerations may include magnetic responsiveness for use with magnetic spring clamps, optical transparency for inspection or imaging workflows, or dimensional stability under laboratory conditions. Materials may be selected based on compatibility with surface treatments such as anodization, passivation, or laser marking used to define alignment guides or visual indicators. In further embodiments, different components of the assembly may be formed from different materials to optimize strength, weight, chemical resistance, or manufacturability for specific regions of the device.

In mechanical systems there are six degrees of freedom, traditionally thought of as three translational degrees of freedom and three rotational degrees of freedom. The three translational degrees of freedom include moving forward and backward on the Y-axis, also referred to as “surge;” moving left and right on the X-axis, also referred to as “sway;” and moving up and down on the Z-axis, also referred to as “heave.” The three rotational degrees of freedom include tilting side to side on the X-axis, also referred to as “roll;” tilting forward and backward on the Y-axis, also referred to as “pitch;” and turning left and right on the Z-axis, also referred to as “yaw.” As mentioned, the disclosed systems are configured to provide restraint of one or more, and possibly all, of these six degrees of freedom.

In embodiments, the first slide and/or the second slide includes a hydrogel. In embodiments, the first slide and/or the second slide includes a polymer attached to the slide. In embodiments, the polymer is a photoresist, wherein the photoresist is a polydimethylsiloxane (PDMS), poly(methyl methacrylate) (PMMA), cyclic olefin copolymer (COC), silsesquioxane resist, an epoxy-based polymer resist, poly(vinylpyrrolidone-vinyl acrylic acid) copolymer resist, an Off-stoichiometry thiol-enes (OSTE) resist, amorphous fluoropolymer resist, a crystalline fluoropolymer resist, polysiloxane resist, or an organically modified ceramic polymer resist. In embodiments, the polymer attached to the slide includes acrylate silanes and polyamines. In embodiments, the polymer attached to the slide includes methacrylic acid N-hydroxysuccinimide ester (NHS-MA). In embodiments, the polymer attached to the slide includes (3-aminopropyl)triethoxysilane (APTES). In embodiments, the polymer attached to the slide includes a copolymer of (3-aminopropyl)triethoxysilane (APTES) and methacrylic acid N-hydroxysuccinimide ester (NHS-MA).

The photoresist (alternatively referred to as a resist) is an active material layer that can be patterned by selective exposure and must “resist” chemical/physical attach of the underlying substrate. A photoresist is a light-sensitive polymer material used to form a patterned coating on a surface. The process begins by coating a substrate (e.g., a glass substrate) with a light-sensitive organic material. A mask with the desired pattern is used to block light so that only unmasked regions of the material will be exposed to light. In the case of a positive photoresist, the photo-sensitive material is degraded by light and a suitable solvent will dissolve away the regions that were exposed to light, leaving behind a coating where the mask was placed. In the case of a negative photoresist, the photosensitive material is strengthened (either polymerized or cross-linked) by light, and a suitable solvent will dissolve away only the regions that were not exposed to light, leaving behind a coating in areas where the mask was not placed. In embodiments, the slide includes an epoxy-based photoresist (e.g., SU-8, SU-8 2000, SU-8 3000, SU-8GLM 2060). In embodiments, the slide includes a negative photoresist. Negative refers to a photoresist whereby the parts exposed to UV become cross-linked (i.e., immobilized), while the remainder of the polymer remains soluble and can be washed away during development.

In embodiments, the slide includes a glass substrate having a surface coated in silsesquioxane resist (e.g., polyhedral oligosilsesquioxanemethacrylate (POSS)), an epoxy-based polymer resist (e.g., SU-8 as described in U.S. Pat. No. 4,882,245), poly(vinylpyrrolidone-vinyl acrylic acid) copolymer resist (e.g., as described in U.S. Pat. No. 7,467,632), or novolaks resist, bisazides resist, or a combination thereof (e.g., as described in U.S. Pat. No. 4,970,276). In embodiments, the resist is removed prior to loading.

A “resist” as used herein is used in accordance with its ordinary meaning in the art of lilthography and refers to a polymer matrix (e.g., a polymer network). In embodiments, the photoresist is a silsesquioxane resist. In embodiments, the photoresist is an epoxy-based polymer resist. In embodiments, the photoresist is a poly(vinylpyrrolidone-vinyl acrylic acid) copolymer resist. In embodiments, the photoresist is an Off-stoichiometry thiol-enes (OSTE) resist. In embodiments, the slide includes a Hydrogen Silsesquioxane (HSQ) polymer (e.g., HSQ resist). In embodiments, the photoresist is an amorphous fluoropolymer resist. In embodiments, the photoresist is a crystalline fluoropolymer resist. In embodiments, the photoresist is a polysiloxane resist. In embodiments, the photoresist is an organically modified ceramic polymer resist. In embodiments, the photoresist includes polymerized alkoxysilyl methacrylate polymers and metal oxides (e.g., SiO₂, ZrO, MgO, Al₂O₃, TiO₂ or Ta₂O₅). In embodiments, the photoresist includes polymerized alkoxysilyl acrylate polymers and metal oxides (e.g., SiO₂, ZrO, MgO, Al₂O₃, TiO₂ or Ta₂O₅). In embodiments, the photoresist includes metal atoms, such as Si, Zr, Mg, Al, Ti or Ta atoms. In embodiments, the slide includes a resist (e.g., a nanoimprint lithography (NIL) resist). Nanoimprint resists can include thermal curable materials (e.g., thermoplastic polymers), and/or UV-curable polymers. In embodiments, the slide is generated by pressing a transparent mold possessing the pattern of interest (e.g., the pattern of wells) into photo-curable liquid film, followed by solidifying the liquid materials via a UV light irradiation. Typical UV-curable resists have low viscosity, low surface tension, and suitable adhesion to the glass substrate. For example, the slide surface is coated in an organically modified ceramic polymer (ORMOCER®, registered trademark of Fraunhofer-Gesellschaft zur Förderung der angewandten Forschung e. V. in Germany). Organically modified ceramics contain organic side chains attached to an inorganic siloxane backbone. Several ORMOCER® polymers are now provided under names such as “Ormocore”, “Ormoclad” and “Ormocomp” by Micro Resist Technology GmbH. In embodiments, the slide includes a resist as described in Haas et al Volume 351, Issues 1-2, 30 Aug. 1999, Pages 198-203, US 2015/0079351A1, US 2008/0000373, US 2010/0160478, or U.S. Pat. No. 10,268,096 B2, each of which is incorporated herein by reference. In embodiments, the slide surface is coated in an organically modified ceramic polymer including (ORMOCER®, registered trademark of Fraunhofer-Gesellschaft zur Förderung der angewandten Forschung e. V. in Germany). In embodiments, the slide surface is coated in an organically modified ceramic polymer wherein the organically modified ceramic polymer includes an inorganic-organic hybrid polymer that includes Si—O bonds. In embodiments, the slide surface is coated in an organically modified ceramic polymer wherein the organically modified ceramic polymer includes an inorganic-organic hybrid polymer that includes Si—C bonds. In embodiments, the slide surface is coated in an organically modified ceramic polymer wherein the organically modified ceramic polymer includes free acrylate moieties. In embodiments, the polymer is an organically modified ceramic polymer wherein the organically modified ceramic polymer includes an inorganic-organic hybrid polymer that includes Si—O bonds. In embodiments, polymer is an organically modified ceramic polymer wherein the organically modified ceramic polymer includes an inorganic-organic hybrid polymer that includes Si—C bonds. In embodiments, the polymer is an organically modified ceramic polymer wherein the organically modified ceramic polymer includes free acrylate moieties. In embodiments, the polymer contains organically crosslinked heteropolysiloxane moieties.

In embodiments, the device provides a slide mating assembly designed for precise alignment and joining of two glass slides, with potential applications in fluid flow, tissue sample analysis, or other areas where accurate slide mating is essential. In embodiments, the slide mating assembly includes a first slide section, a second slide section, a hinge assembly, and a lock assembly, each working in concert to facilitate secure and accurate assembly and use of the slides. In embodiments, the device includes alignment features (e.g., 1, 2, 3, 4, 5, 6, 7, 8, 9, 10, 11, 12, 13, 14, 15, 16, 17, 18, 19, 20, or more alignment features) disposed at the outer edge of a receptacle within the slide mating assembly. In embodiments, the slide mating assembly has two alignment features. Alignment features include raised features (e.g., blocks) against which the glass slide can be in direct contact. Other examples of alignment features include, but are not limited to, pins, posts, protrusions, ridges, prongs, etc., that are brought into contact with or inserted into the glass slide and provide a physical barrier to movement. Additional embodiments include recessed or contoured features shaped to receive corners or edges of the glass slide to passively restrict lateral and rotational displacement. In some implementations, the alignment features are configured to engage only upon closure of the mating assembly, providing a guided interaction that initiates with long-axis contact and terminates with short-axis contact to ensure sequential registration. In embodiments, the alignment features are positioned and dimensioned to constrain the slide within a defined tolerance, such as 100 microns or less in one or more axes.

The first slide section is configured with an upper surface specifically sized and shaped to receive a first glass slide. In embodiments, this first glass slide may be a drilled slide, incorporating one or more input and output ports. These ports can be used for introducing or extracting fluids, gases, or other substances. Additionally, the first glass slide may contain one or more channels designed to direct fluid flow. Alternatively, it may include a gasket, which serves to define one or more channels, effectively sealing and guiding the flow of any contained substances. An adhesive layer may also be applied to the first glass slide to enhance its stability within the assembly and ensure a secure seal, preventing any potential leakage during operation.

In embodiments, the second solid support includes a gasket, wherein the gasket defines the reaction chamber. In embodiments, the gasket includes silicone, polyimide, fluorocarbon elastomer, ethylene propylene diene, polychloroprene, polytetrafluoroethylene, nitrile rubber, butyl rubber, natural rubber, thermoplastic elastomer, or a combination thereof. In embodiments, the second solid support includes a spacer element to form an offset surface. In embodiments, the second solid support includes one or more channels. The channel(s) may be formed by affixing a spacer element to create a defined gap or channel through which liquid can flow or be contained. The spacer element may be made of any suitable material, for example resin, glass, plastic, silicon, an adhesive, or a combination thereof. In embodiments, the spacer element includes a first adhesive in contact with the functionalized glass slide and second adhesive in contact with the second solid support. In embodiments, the spacer element includes a first adhesive in contact with the functionalized glass slide, a second adhesive in contact with the second solid support, and a carrier material in contact with the first adhesive and the second adhesive. The depth of the resulting channel may be controlled by including a carrier material (e.g., one or more polymer or copolymer layers) between the adhesives. In embodiments, the spacer element may form the walls of the reaction chamber, wherein the reaction chamber includes the sample. In embodiments, the spacer element is further attached to the coupling agent attached the polymer of the first solid support. In embodiments, the gasket is referred to as a spacer element.

The second slide section likewise includes an upper surface, which is sized and shaped to receive a second glass slide. In some embodiments, this second glass slide is intended to hold a tissue sample, offering a designated area for sample retention and analysis.

In embodiments, a hinge assembly movably connects the first slide section to the second slide section, allowing the slide mating assembly to transition between an open state and a closed state. In the closed state, the upper surfaces of the first and second slide sections are positioned in direct, juxtaposed contact, ensuring precise alignment and secure interaction between the slides.

In embodiments, the slide mating assembly includes a serialization marking disposed on the base of the assembly, the serialization marking identifying a unique identifier associated with the assembly. The serialization marking may be applied using laser etching, engraving, printing, or molding, and may be positioned in a recessed or protected area, such as within a slot or cavity on the base, to minimize wear during handling. In embodiments, the unique identifier may include a serial number, lot code, or other designation to enable traceability for manufacturing, quality assurance, or field servicing. The marking may be presented in a human-readable format, a machine-readable format, or both, and may include alphanumeric codes, barcodes, or matrix symbols.

In various embodiments, additional functional elements may be incorporated to improve ease of use and reliability. For example, alignment banking features may be included to ensure that the alignment elements do not extend beyond the thickness of the glass slides. This helps prevent chipping or damage to the slides, particularly at the edges, while allowing precise alignment. A Poka-Yoke (mistake-proofing) feature may be integrated to ensure correct installation of the slides, particularly when working with drilled glass or tissue samples. This feature minimizes the risk of assembly errors by guiding users through proper component placement and orientation. Clear status indicators are also provided, marking ‘Open’ and ‘Closed’ states for user guidance. These indicators ensure that the user can confidently confirm the alignment and status of the assembly at a glance, reducing the chance of accidental misuse.

In some embodiments, a damper mechanism may be included to regulate the closing speed of the assembly. This optional feature prevents accidental slamming of the assembly, which could otherwise risk damaging the glass slides or disturbing sensitive samples. The damper mechanism may include a spring-loaded piston, elastomeric component, or friction-based hinge element configured to slow the rate of closure through mechanical resistance. In embodiments, the damper is integrated within the hinge assembly or positioned adjacent to the rotational axis between the first and second slide sections. The damping force may be passive or adjustable, depending on the material properties and geometry of the damper components. In some examples, the damper may be designed to engage during the final portion of the closure arc, reducing impact forces at the point of glass-to-glass alignment.

In embodiments, at least one lock assembly includes a lever that transitions the lock assembly between a locked state and an unlocked state. In embodiments, the at least one lock assembly includes a lever that transitions the at least one lock assembly between a locked state and an unlocked state. By operating the lever, the user can easily secure the assembly in a desired position or unlock it for adjustments. In further embodiments, the lock assembly may feature one or more levers, each configured to independently transition the lock assembly between the locked and unlocked states, allowing for versatile control over the locking mechanism, enabling the user to engage or disengage the assembly with precision and ease.

In embodiments, the at least one lock assembly includes: a drilled glass slide section lock assembly in the drilled glass slide section; and a tissue slide section lock assembly in the tissue slide section.

In embodiments, the slide mating assembly aligns a tissue slide with a drilled glass slide when the slide mating assembly is in the closed state. The alignment may be achieved through contact between predefined datum features on the assembly and corresponding physical features of the slides, such as edges, corners, or chamfers. In certain embodiments, the alignment process is guided by the geometry of the hinge and cam profiles, which are configured to engage the long axis of the slides before the short axis, ensuring sequential registration. This controlled engagement assists in achieving repeatable and accurate positioning of the slides along X, Y, and rotational (theta) axes. A cam refers to a mechanical component having a profile that converts rotational or linear motion into a prescribed, often non-linear, movement in an associated part. In embodiments, a cam may include a contoured surface, slot, or protrusion that interacts with a follower element, pin, or mating feature to control timing, alignment, or mechanical engagement during actuation of the slide mating assembly. The cam may be rotational or stationary and may be formed from metal, plastic, or composite materials, depending on the required durability and functional characteristics of the slide assembly. In embodiments, the cam is metal.

In embodiments, the hinge assembly that rotatably couples the drilled glass slide section to the tissue slide section in a clamshell manner. The clamshell configuration provides a pivotal axis that allows the drilled glass slide section and the tissue slide section to move between an open state, where they are separated for easy access, and a closed state, where the sections are aligned and in juxtaposed contact. By employing a clamshell design, the hinge assembly facilitates precise alignment of the slides, minimizes the risk of misalignment during closure, and supports the secure containment of any materials or samples positioned between the slides. This clamshell motion further enhances ease of use, as it allows users to handle the assembly with minimal adjustments while maintaining stable alignment of the glass slides throughout the operation.

In embodiments, at least one of the tissue slide section and the drilled slide section includes an alignment feature that aligns a respective slide with the tissue slide section or the drilled slide section. In embodiments, the alignment feature includes a dowel pin positionable at a chamfered edge of respective slide. The dowel pin interacts with the chamfered edge to guide the slide into the correct alignment, providing a simple and effective method for achieving exact positioning. Employing a dowel pin and chamfered edge configuration improves ease of assembly and also reinforces the stability of the mounted slides, maintaining secure and accurate positioning throughout operation and handling.

In embodiments, the slide includes an IR reflective coating. In embodiments, the IR reflective coating is attached to the slide. In embodiments, the IR reflective coating is attached to the slide, wherein the IR reflective coating is in contact with the polymer described herein. In embodiments, the IR reflective coating includes metal oxides. In embodiments, the IR reflective coating includes titanium dioxide, zinc oxide, tin oxide, tantalum pentoxide, silicon dioxide, indium tin oxide, silver-based coating, ceramic-based coating or a combination thereof. In embodiments, the IR reflective coating includes SiO₂, TiO₂, Al₂O₃ and Ta₂O₅ and fluorides such as MgF₂, LaF₃ and AlF₃. In embodiments, the IR reflective coating includes tantalum pentoxide (Ta₂O₅) and silicon dioxide (SiO₂). In embodiments, the infrared (IR) reflective coating includes one or more layers of silicon dioxide (SiO₂) and tantalum pentoxide (Ta₂O₅). In embodiments, the infrared (IR) reflective coating includes alternating layers of silicon dioxide (SiO₂) and tantalum pentoxide (Ta₂O₅), wherein the layer of silicon dioxide (SiO₂) is in direct or indirect contact with the polymer (e.g., the polymer described herein). In embodiments, the infrared (IR) reflective coating includes alternating layers of silicon dioxide (SiO₂) and tantalum pentoxide (Ta₂O₅), wherein the layer of tantalum pentoxide (Ta₂O₅) is in direct or indirect contact with the polymer (e.g., the polymer described herein).

In embodiments, the IR reflective coating reflects near-infrared radiation (NIR). In embodiments, the IR reflective coating reflects mid-or far-infrared radiation. In embodiments, the IR reflective coating reflects wavelengths greater than 750 nm. In embodiments, the IR reflective coating reflects wavelengths greater than 760 nm. In embodiments, the IR reflective coating reflects wavelengths greater than 770 nm. In embodiments, the IR reflective coating reflects wavelengths greater than 780 nm. In embodiments, the IR reflective coating reflects wavelengths greater than 790 nm. In embodiments, the IR reflective coating reflects wavelengths greater than 800 nm. In embodiments, the IR reflective coating reflects wavelengths from about 750 nm to 1,000 μm. In embodiments, the infrared (IR) reflective coating includes one or more layers of silicon dioxide (SiO₂) and tantalum pentoxide (Ta₂O₅). A multilayer configuration leverages the distinct optical properties of both materials to enhance the IR reflectivity. Silicon dioxide, known for its low refractive index, and tantalum pentoxide, recognized for its high refractive index, are alternately layered to create a stack that exhibits high reflectance in the infrared spectrum. The alternating layers of SiO₂ and Ta₂O₅ result in constructive interference of light at specific wavelengths, thereby enhancing the IR reflective capability of the coating. The number and thickness of these layers can be tailored to target specific wavelengths within the IR range, or permitting a certain percentage of radiation to transmit. For example, the IR reflective coating may reflect 2-3%, 2-6%, or 2 to 10% of the total IR radiation, and it absorbs or transmits the remaining IR radiation (e.g., greater than about 90% of the IR radiation). In embodiments, the IR reflective coating reflects about 1%, about 2%, about 3%, about 4%, about 5%, about 6%, about 7%, about 8%, about 9%, or about 10% of the total IR radiation.

In embodiments, the IR reflective coating aids autofocus mechanisms in optical instruments (e.g., fluorescence microscopy instruments) to provide consistent signal across various z-heights (e.g., the depth of an image). In embodiments, the IR reflective coating increases the amount of light reflected to the autofocus sensor to provide consistent signal across various z-heights. In embodiments, the IR reflective coating improves the signal to noise ratio of an image acquired by an optical instrument.

In embodiments, the first slide includes one or more channel(s). In embodiments, the first slide includes a channel bored into the first slide. In embodiments, the first slide includes a plurality of channels bored into the first slide. In embodiments, the first slide includes 2 channels bored into the first slide. In embodiments, the first slide includes 3 channels bored into the first slide. In embodiments, the first slide includes 4 channels bored into the first slide. In embodiments, the width of the channel is from about 1 to 5 mm. In embodiments, the width of the channel is from about 5 to 10 mm. In embodiments, the width of the channel is from about 10 to 15 mm. In embodiments, the width of the channel is from about 5 mm. In embodiments, the width of the channel is from about 11 mm.

In embodiments, the second slide includes one or more channel(s). In embodiments, the second slide includes a channel bored into the second slide. In embodiments, the second slide includes a plurality of channels bored into the second slide. In embodiments, the second slide includes 2 channels bored into the second slide. In embodiments, the second slide includes 3channels bored into the second slide. In embodiments, the second slide includes 4 channels bored into the second slide. In embodiments, the width of the channel is from about 1 to 5 mm. In embodiments, the width of the channel is from about 5 to 10 mm. In embodiments, the width of the channel is from about 10 to 15 mm. In embodiments, the width of the channel is from about 5 mm. In embodiments, the width of the channel is from about 11 mm.

In embodiments, the second slide includes a gasket (alternatively referred to herein as a spacer), wherein the gasket defines the reaction chamber. In embodiments, the gasket defines a perimeter of a channel. In embodiments, the gasket defines a perimeter of two or more channels. In embodiments, the gasket includes silicone, polyimide, fluorocarbon elastomer, ethylene propylene diene, polychloroprene, polytetrafluoroethylene, nitrile rubber, butyl rubber, natural rubber, thermoplastic elastomer, or a combination thereof. In embodiments, the second slide includes a spacer element to form an offset surface. In embodiments, the second slide includes one or more channels. The channel(s) may be formed by affixing a spacer element to create a defined gap or channel through which liquid can flow or be contained. The spacer element may be made of any suitable material, for example resin, glass, plastic, silicon, an adhesive, or a combination thereof. In embodiments, the spacer element includes a first adhesive in contact with the functionalized glass slide and second adhesive in contact with the second slide. In embodiments, the spacer element includes a first adhesive in contact with the functionalized glass slide, a second adhesive in contact with the second slide, and a carrier material in contact with the first adhesive and the second adhesive. The depth of the resulting channel may be controlled by including a carrier material (e.g., one or more polymer or copolymer layers) between the adhesives. In embodiments, the spacer element may form the walls of the reaction chamber, wherein the reaction chamber includes the sample. In embodiments, the spacer element is further attached to the copolymer attached the polymer of the first slide. In embodiments, the gasket is referred to as a spacer element.

In embodiments, the flow cell assembly further includes 2, 3, 4, 5, 6, 7, 8, 9, 10, 11, or 12 reaction chambers (e.g., channels). In embodiments, the flow cell assembly includes 2 distinct reaction chambers (e.g., channels). In embodiments, the flow cell assembly includes 4 distinct reaction chambers (e.g., channels). In embodiments, each reaction chamber includes a depth of about 50 μm to about 150 μm. In embodiments, the reaction chamber includes a depth of about 80 μm to about 110 μm. In embodiments, the reaction chamber includes a width of about 4 μm to about 15 μm.

In embodiments, the reaction chamber is a channel on the flow cell. In embodiments, the channel includes a depth of about 50 μm to about 150 μm. In embodiments, the channel includes a depth of about 50 μm. In embodiments, the channel includes a depth of about 60 μm. In embodiments, the channel includes a depth of about 70 μm. In embodiments, the channel includes a depth of about 80 μm. In embodiments, the channel includes a depth of about 90 μm. In embodiments, the channel includes a depth of about 100 μm. In embodiments, the channel includes a depth of about 110 μm. In embodiments, the channel includes a depth of about 120 μm. In embodiments, the channel includes a depth of about 130 μm. In embodiments, the channel includes a depth of about 140 μm. In embodiments, the channel includes a depth of about 71 μm. In embodiments, the channel includes a depth of about 72 μm. In embodiments, the channel includes a depth of about 73 μm. In embodiments, the channel includes a depth of about 74 μm. In embodiments, the channel includes a depth of about 75 μm. In embodiments, the channel includes a depth of about 76 μm. In embodiments, the channel includes a depth of about 77 μm. In embodiments, the channel includes a depth of about 78 μm. In embodiments, the channel includes a depth of about 79 μm. In embodiments, the channel includes a depth of 50 μm to 150 μm. The depth of the channel may be referred to as the height of the channel or the distance between the first and second slides. In embodiments, the channel includes a depth of 50 μm. In embodiments, the channel includes a depth of 60 μm. In embodiments, the channel includes a depth of 70 μm. In embodiments, the channel includes a depth of 80 μm. In embodiments, the channel includes a depth of 90 μm. In embodiments, the channel includes a depth of 100 μm. In embodiments, the channel includes a depth of 110 μm. In embodiments, the channel includes a depth of 120 μm. In embodiments, the channel includes a depth of 130 μm. In embodiments, the channel includes a depth of 140 μm. In embodiments, the channel includes a depth of 150 μm. In embodiments, the channel includes a depth of 160 μm. In embodiments, the channel includes a depth of 170 μm. In embodiments, the channel includes a depth of 180 μm. In embodiments, the channel includes a depth of 190 μm. In embodiments, the channel includes a depth of 200 μm.

In embodiments, the first slide or the second slide includes a port. In embodiments, the first slide or the second slide includes an inlet port and an outlet port. In embodiments, the first slide includes an inlet port and an outlet port. In embodiments, the second slide includes an inlet port and an outlet port. In embodiments, the first slide includes an inlet port. In embodiments, the second slide includes an inlet port. In embodiments, the first slide includes an outlet port. In embodiments, the second slide includes an outlet port. In embodiments, each port is about 0.50 to about 1.00 mm in diameter. In embodiments, each port is 0.50 to 1.00 mm in diameter. In embodiments, each port is 0.7 to 0.8 mm in diameter. In embodiments, each port is 0.50, 0.55, 0.60, 0.65, 0.70, 0.75, 0.80, 0.85, 0.90, 0.95, or 1.00 mm in diameter. In embodiments, each port is 70, 75, or 80 mm in diameter. In embodiments, each port is about 50 to about 100 mm in diameter. In embodiments, each port is 50 to 100 mm in diameter. In embodiments, each port is 50, 55, 60, 65, 70, 75, 80, 85, 90, 95, or 100 mm in diameter. In embodiments, each port is 70, 75, or 80 mm in diameter.

In embodiments, the first slide includes a pressure sensitive adhesive (PSA) attached to a glass slide, wherein the glass slide includes inlet and outlet ports. In embodiments, first slide includes a pressure sensitive adhesive (PSA) laminated to a glass slide, wherein the glass slide includes inlet and outlet ports. In embodiments, the second slide includes a pressure sensitive adhesive (PSA) attached to a glass slide, wherein the glass slide includes inlet and outlet ports. In embodiments, second slide includes a pressure sensitive adhesive (PSA) laminated to a glass slide, wherein the glass slide includes inlet and outlet ports. In embodiments, the pressure sensitive adhesive has a thickness of about 10 μm to about 100 μm. In embodiments, the pressure sensitive adhesive has a thickness of about 70 μm to about 100 μm. In embodiments, the pressure sensitive adhesive has a thickness of about 100 μm to about 200 μm. In embodiments, the pressure sensitive adhesive has a thickness of about 200 μm to about 500 μm. In embodiments, the pressure sensitive adhesive has a thickness of about 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, 100 μm, 101 μm, 102 μm, 103 μm, 104 μm, 105 μm, 106 μm, 107 μm, 108 μm, 109 μm, 110 μm, 111 μm, 112 μm, 113 μm, 114 μm, 115 μm, 116 μm, 117 μm, 118 μm, 119 μm, 120 μm, 121 μm, 122 μm, 123 μm, 124 μm, 125 μm, 126 μm, 127 μm, 128 μm, 129 μm, 130 μm, 131 μm, 132 μm, 133 μm, 134 μm, 135 μm, 136 μm, 137 μm, 138 μm, 139 μm, 140 μm, 141 μm, 142 μm, 143 μm, 144 μm, 145 μm, 146 μm, 147 μm, 148 μm, 149 μm, 150 μm or greater. In embodiments, the pressure sensitive adhesive has a thickness of about 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, 155 μm, 160 μm, 165 μm, 170 μm, 175 μm, 180 μm, 185 μm, 190 μm, 195 μm, 200 μm, 205 μm, 210 μm, 215 μm, 220 μm, 225 μm, 230 μm, 235 μm, 240 μm, 245 μm, 250 μm, or greater.

In embodiments, the pressure sensitive adhesive (PSA) includes to a first adhesive attached to a carrier polymer, where the carrier polymer is further attached to a second adhesive. In embodiments, the carrier polymer is between the first adhesive and the second adhesive. In embodiments, the adhesive includes an acrylic material. In embodiments, the adhesive includes rubber. In embodiments, the adhesive includes silicone. In embodiments, a variety of adhesive materials are utilized for fabricating leak-free chambers in a flow cell, each selected based on their unique properties and the specific requirements of the application. Acrylic-based adhesives are favored for their strong bond and resistance to environmental factors, while rubber-based adhesives are chosen for their flexibility and resilience in applications requiring movement. Silicone adhesives are notable for their high-temperature resistance and moisture-proof sealing capabilities. Epoxy resins offer unparalleled strength and chemical resistance, making them ideal for demanding industrial applications. Polyurethane adhesives, known for their balance of strength, flexibility, and chemical resistance, are versatile in bonding diverse materials. Lastly, cyanoacrylates, are valued for their rapid setting and strong bonding properties, essential for quick and reliable leak prevention.

In embodiments, the first slide includes a plurality of channels etched in glass that is capable of being in contact with a UV-curable adhesive. In embodiments, the second slide includes a plurality of channels etched in glass that is capable of being in contact with a UV-curable adhesive. A UV-curable adhesive is an adhesive that hardens or sets when exposed to ultraviolet light. In embodiments, the UV-curing adhesive cures when exposed to wavelengths about 365 nm to about 405 nm. In embodiments, the UV-curing adhesive cures when exposed to wavelength of about 405 nm. In embodiments, the UV-curable adhesive is chemically compatible with glass. The UV-curing adhesive includes a mixture of photo-initiator that, upon exposure to UV light, initiates a polymerization reaction that converts the liquid adhesive into a solid polymer, resulting in a rapid curing process. In embodiments, use of a UV-curing adhesive on the first slide provides channel depth consistency and a leak-free seal. In embodiments, use of a UV-curing adhesive on the second slide provides channel depth consistency and a leak-free seal.

In embodiments, the first slide is a tissue slide and includes one or more tissue sections immobilized thereto. In embodiments, the tissue includes a thickness of about 1 μm to about 20 μm. In embodiments, the tissue includes a thickness of about 1 μm to about 10 μm. In embodiments, the tissue includes a thickness of about 2 μm to about 3 μm. In embodiments, the tissue includes a thickness of about 4 μm to about 6 μm. In embodiments, the tissue includes a thickness of about 4 μm. In embodiments, the tissue includes a thickness of about 5 μm. In embodiments, the tissue includes a thickness of about 6 μm. In embodiments, the tissue includes a thickness of about 7 μm. In embodiments, the tissue includes a thickness of about 8 μm. In embodiments, the tissue includes a thickness of about 9 μm. In embodiments, the tissue includes a thickness of about 10 μm.

In embodiments, the tissue section includes a tissue or a cell (e.g., a plurality of cells such as blood cells). In embodiments, the tissue section includes one or more cells. In embodiments, the tissue section is embedded in an embedding material including paraffin wax, polyepoxide polymer, polyacrylic polymer, agar, gelatin, celloidin, cryogel, optimal cutting temperature (OCT) compositions, glycols, or a combination thereof. In embodiments, the tissue section is embedded in an embedding material including paraffin wax. In embodiments, the tissue section is embedded in an embedding material including a polyepoxide polymer. In embodiments, the tissue section is embedded in an embedding material including polyacrylic polymer. In embodiments, the tissue section is embedded in an embedding material including agar. In embodiments, the tissue section is embedded in an embedding material including gelatin. In embodiments, the tissue section is embedded in an embedding material including celloidin. In embodiments, the tissue section is embedded in an embedding material including a cryogel. In embodiments, the tissue section is embedded in an embedding material including an optimal cutting temperature (OCT) compositions. In embodiments, the tissue section is embedded in an embedding material including one or more glycols. Tissue sections may be obtained from a subject by any means known and available in the art. In particular embodiments, a tissue section, e.g., a tumor tissue sample, is obtained from a subject by fine needle aspiration, core needle biopsy, stereotactic core needle biopsy, vacuum-assisted core biopsy, or surgical biopsy. In particular embodiments, the surgical biopsy is an incisional biopsy, which removes only part of the suspicious area.

In embodiments, the assembly described herein include focusing on the beads at different depths to calibrate and image in three dimensions. In embodiments, the particle is configured for use in multi-channel fluorescence imaging for calibration or focus adjustment. In embodiments, the particles aid calibration of optical instruments used herein (e.g., fluorescence microscopy instruments). In embodiments, the particles used herein emit fluorescence at known wavelengths, which aids the calibration of fluorescence detection channels on optical instruments used herein. In embodiments, the particles used herein aids the testing the image quality and spatial resolution across different z-heights (e.g., depth of an image acquired of a tissue section described herein).

In embodiments, the slide mating assembly comprises a drilled glass slide section with an upper surface specifically designed to hold a drilled glass slide securely and in proper alignment. In embodiments, a tissue slide section is included, featuring an upper surface configured to receive and position a tissue slide for use in various applications.

In embodiments, the assembly incorporates a hinge assembly that movably couples the drilled glass slide section to the tissue slide section, allowing the assembly to transition smoothly between an open state and a closed state. The closed state positions the upper surface of the drilled glass slide section in juxtaposed contact with the upper surface of the tissue slide section, ensuring alignment and interaction. In embodiments, at least one lock assembly is integrated into the design to secure the assembly in either the open or closed state. The lock assembly provides stability and ensures the slides remain in place during use or transport, enhancing precision and reliability for applications requiring secure slide positioning.

In embodiments, the upper surface of the tissue slide section or the glass slide section includes at least one finger well (705) formed of an indentation sized and shaped to receive a finger of a user. In embodiments, the slide mating assembly includes at least one finger well (705) formed as an indentation on the upper surface of either the tissue slide section or the glass slide section. In embodiments, the finger well (705) is configured with dimensions suitable for receiving a humans finger, with potential sizes ranging from 10 mm to 25 mm in diameter and a depth of 2 mm to 6 mm, depending on ergonomic requirements. The shape of the finger well (705) may vary, including circular, oval, or semi-circular profiles, to accommodate user preferences or facilitate manufacturing processes. In embodiments, the finger well (705) is positioned in a location on the upper surface that optimizes accessibility and ease of use during the transition between the open and closed states. The indentation may also feature beveled or rounded edges to improve comfort and minimize wear on the user's finger. Alternative designs for the finger well (705) may include texturing or ridges within the indentation to provide additional grip or tactile feedback during handling.

In embodiments, the upper surface of the tissue slide section or the glass slide section includes at least one moat (710) configured to drain debris. In embodiments, the upper surface of the tissue slide section or the glass slide section includes at least one moat (710) configured to drain debris. In embodiments, the moat (710) may be positioned along the perimeter or near critical areas of the upper surface to effectively collect and channel debris away from the operational regions of the slides. The moat (710) may have a depth ranging from 1 mm to 5 mm and a width between 2 mm and 10 mm, depending on the intended application and debris volume. In embodiments, the shape of the moat (710) may be circular, rectangular, or irregular, with the design tailored to maximize debris collection while maintaining compatibility with the slide's overall structure. The moat (710) may be sloped or include angled edges to facilitate drainage, guiding debris toward designated disposal points or preventing accumulation that could interfere with operation. Additional features, such as a textured or hydrophobic inner surface, may be incorporated to further improve debris flow and reduce clogging within the moat (710). In embodiments, the moat (710) may be integrally formed during molding or machining of the slide section to ensure dimensional consistency and minimize manufacturing steps. In some cases, the moat (710) may be configured to interface with removable or replaceable inserts that collect debris for disposal. In embodiments, the moat (710) may serve as a visual boundary to guide user placement of slides, further reducing the risk of contamination to active regions. The moat (710) may also be positioned to isolate particulate matter generated during loading or removal of slides, particularly in high-throughput environments where repeated handling may introduce debris.

In embodiments, wherein the upper surface of the tissue slide section or the glass slide section includes at least one visible line (715) that provides an indication of a correct orientation of a tissue slide or drilled glass slide. In embodiments, the upper surface of the tissue slide section or the glass slide section includes at least one visible line (715) configured to indicate the correct orientation of a tissue slide or drilled glass slide. In alternative embodiments, the indication of orientation may be provided by a raised bumper or edge instead of a visible line. The raised bumper or edge may extend slightly above the surface, with a height of about 0.5 mm to about 2 mm, to create a tactile and visual guide for slide placement. In embodiments, the raised bumper or edge may run along one or more sides of the slide section or form specific alignment points that correspond to the edges or corners of the tissue slide or drilled glass slide to help prevent misalignment and ensure consistent orientation during operation. The bumper or edge may be constructed from the same material as the slide section or include a contrasting color or texture to enhance visibility and usability.

In embodiments, wherein the upper surface of the tissue slide section or the glass slide section includes at least one visible line (715) that provides an indication of a correct orientation of a tissue slide or drilled glass slide. In embodiments, the upper surface of the tissue slide section or the glass slide section includes at least one visible line (715) that provides an indication of the correct orientation of a tissue slide or drilled glass slide. In embodiments, the visible line (715) may be etched, painted, or laser-marked onto the surface, offering a durable and precise alignment guide. The line (715) can be positioned strategically to correspond with key features of the tissue slide or drilled glass slide, aiding in proper placement during use. In embodiments, the visible line (715) may vary in design, such as a solid, dashed, or dotted line, and may be configured to form alignment grids or crosshair patterns for enhanced precision. The line (715) may also include high-contrast colors, such as black or fluorescent shades, to improve visibility in environments with low lighting or glare. Additional alternatives to the visible line (715) may include tactile features like raised edges, textured grooves, or recessed channels that serve as physical guides for orientation.

In embodiments, the assembly includes an unlock blocking element (720) formed of an enlarged body that extends upwardly from the drilled glass slide section, wherein unlock blocking element is configured to prevent damage to a drilled glass slide. In embodiments, the assembly includes an unlock blocking element (720) formed of an enlarged body that extends upwardly from the drilled glass slide section. In embodiments, the unlock blocking element (720) is configured to prevent damage to a drilled glass slide by providing a physical barrier that limits movement or misalignment during handling or operation. In embodiments, the unlock blocking element (720) may be positioned adjacent to the area where the drilled glass slide is mounted to ensure optimal protection. The enlarged body of the unlock blocking element (720) may have dimensions ranging from 5 mm to 20 mm in height and 3 mm to 10 mm in width, depending on the size and fragility of the drilled glass slide. The body may be constructed from a resilient material, such as silicone, rubber, or a polymer, to absorb impacts and reduce the likelihood of chipping or cracking the glass slide. In embodiments, the unlock blocking element (720) may include a textured or curved surface to further minimize contact pressure on the drilled glass slide. Alternative designs for the unlock blocking element (720) may feature multiple enlarged bodies or a continuous raised edge, ensuring broader protection across the surface of the drilled glass slide.

In embodiments, the assembly includes a base pad (725) extending outwardly from the tissue slide section, the pad positioned so that a user can place a finger on the pad to secure a position of the tissue slide section on a flat surface. In embodiments, the assembly includes a base pad (725) extending outwardly from the tissue slide section. In embodiments, the base pad (725) is positioned to allow a user to place a finger on the pad to secure the position of the tissue slide section on a flat surface. The base pad (725) enhances stability during use by providing a designated contact area for the user to apply pressure, preventing unwanted movement or tilting of the tissue slide section. In embodiments, the base pad (725) may have a width of 10 mm to 30 mm and a thickness of 1 mm to 5 mm, depending on ergonomic and operational requirements. The pad may feature a non-slip surface, such as a textured or rubberized coating, to improve grip and ensure secure placement on various surfaces. In embodiments, the pad may be integrated seamlessly into the tissue slide section or attached as a separate component, depending on the manufacturing process. In alternative designs, the base pad (725) may include additional features, such as beveled edges for comfort or markings to guide finger placement. The placement of the base pad (725) may be offset or symmetrically aligned with the tissue slide section to accommodate user preferences and aids in ease of handling.

In embodiments, the assembly includes an upraised corner exclusion pad (730) on the upper surface of the tissue slide section, wherein the corner exclusion pad is configured to properly position a tissue slide on the upper surface of the tissue slide section. In embodiments, the assembly includes an upraised corner exclusion pad (730) located on the upper surface of the tissue slide section. In embodiments, the corner exclusion pad (730) is configured to properly position a tissue slide by creating a physical boundary that ensures precise alignment on the upper surface of the tissue slide section. In embodiments, the corner exclusion pad (730) may extend upwardly by 1 mm to 3 mm and may have a width ranging from 2 mm to 10 mm, depending on the size and positioning requirements of the tissue slide. The exclusion pad (730) may be rectangular, square, or rounded in shape and is positioned at one or more corners of the tissue slide section to provide a secure alignment point for the slide. The corner exclusion pad (730) may be made of the same material as the tissue slide section or a softer material such as rubber or silicone to prevent damage to the tissue slide during placement. In alternative embodiments, the exclusion pad (730) may include a textured surface or beveled edges to improve slide positioning and minimize the risk of accidental misalignment. The placement of the pad ensures that the tissue slide remains securely oriented during operation, enhancing the reliability of the assembly.

In embodiments, the assembly includes a handle (735) on the drilled glass slide section, the handle having a rotatable portion that rotates as the slide mating assembly transitions between the open state and the closed state. In embodiments, the assembly includes a handle (735) positioned on the drilled glass slide section, wherein the handle includes a rotatable portion that rotates as the slide mating assembly transitions between the open state and the closed state. In embodiments, the rotatable portion of the handle (735) facilitates smooth and controlled operation by providing a grip point that moves in synchronization with the hinge assembly, ensuring ease of handling during use. The handle (735) may be constructed from a durable material, such as metal, plastic, or a composite, to withstand repeated use. In embodiments, the rotatable portion may include an ergonomic design with dimensions ranging from 20 mm to 50 mm in length and 5 mm to 15 mm in diameter, accommodating a comfortable grip for a range of users. In embodiments, the handle (735) may be configured with a textured or rubberized surface to enhance grip and prevent slippage during operation. The rotatable mechanism may utilize bearings, pivots, or friction-reducing components to ensure seamless movement as the assembly transitions between states. In alternative embodiments, the handle (735) may incorporate additional features such as a locking mechanism to hold the assembly in the open or closed state, or a spring-loaded return for added functionality.

In embodiments, the assembly includes a tactile pad (740) on an outer surface of the tissue slide section or the drilled glass slide section, the tactile pad configured to secure a position of the slide mating assembly when in contact with a flat surface. In embodiments, the tactile pad is rubber. In embodiments, the assembly includes a tactile pad (740) positioned on the bottom surface of the tissue slide section or the drilled glass slide section. The tactile pad (740) is configured to provide grip against a table or other flat surface, ensuring the slide mating assembly remains securely in place during use. In embodiments, the tactile pad (740) is constructed from rubber or a similar high-friction material to enhance stability and resist sliding. The pad may have a thickness ranging from 1 mm to 5 mm, with dimensions tailored to the size of the assembly, such as lengths between 10 mm and 50 mm. The tactile pad (740) may cover the entire bottom surface or be segmented into multiple smaller pads strategically placed at corners or edges to optimize grip and balance. The tactile pad (740) may feature a textured surface, such as ridges, grooves, or a dimpled pattern, to increase contact friction with the flat surface. In embodiments, the pad is secured to the bottom surface using durable adhesives, integrated during manufacturing, or attached with mechanical fasteners to maintain its position over time. The placement and design of the tactile pad (740) ensure reliable stability, even during operations that involve handling or applying pressure to the slide mating assembly.

In embodiments, the drilled glass slide section has an enlarged extension portion (745) configured to interact with the hinge assembly to prevent the slide mating assembly from opening beyond 180 degrees. In embodiments, the drilled glass slide section includes an enlarged extension portion (745) configured to interact with the hinge assembly. The enlarged extension portion (745) is designed to limit the range of motion of the hinge assembly, thereby preventing the slide mating assembly from opening beyond 180 degrees. In embodiments, the enlarged extension portion (745) may extend outwardly from the drilled glass slide section by 5 mm to 20 mm and may include a flat or curved contact surface that engages with a corresponding stop feature within the hinge assembly. This interaction ensures that the slide mating assembly opens to a precise and controlled angle, protecting the structural integrity of the assembly and maintaining the alignment of the slides. The enlarged extension portion (745) may be formed integrally with the drilled glass slide section or attached as a separate component using fasteners or adhesives. In alternative embodiments, the extension portion (745) may include reinforced materials, such as metal or high-strength polymers, to withstand repeated impacts with the hinge assembly. The design may also incorporate angled or cushioned surfaces to absorb force and reduce wear during operation, ensuring consistent and reliable functionality over time.

In an aspect is provided a solid support (e.g., a planar solid support) including a tissue section and plurality of particles as described herein, including embodiments. In embodiments, the tissue section is embedded in an embedding material, for example an embedding material including paraffin wax, polyepoxide polymer, polyacrylic polymer, agar, gelatin, celloidin, cryogel, optimal cutting temperature (OCT) composition, glycols, or a combination thereof. In embodiments, the tissue section includes a thickness of about 1 μm to about 20 μm. In embodiments, the tissue includes a thickness of about 1 μm to about 10 μm. In embodiments, the tissue includes a thickness of about 2 μm to about 3 μm. In embodiments, the tissue includes a thickness of about 4 μm to about 6 μm. In embodiments, the tissue includes a thickness of about 4 μm. In embodiments, the tissue includes a thickness of about 5 μm. In embodiments, the tissue includes a thickness of about 6 μm. In embodiments, the tissue includes a thickness of about 7 μm. In embodiments, the tissue includes a thickness of about 8 μm. In embodiments, the tissue includes a thickness of about 9 μm. In embodiments, the tissue includes a thickness of about 10 μm. In embodiments, the particles are arrayed in a random order, such as when a suspension of particles is fluidically deposited onto a slide or support surface, dried, and subsequently overlaid with a tissue section. In such embodiments, a second plurality of particles may be introduced after the tissue section has been positioned, for example by flowing a bead suspension across the sample, such that particles are distributed both beneath and above the tissue. This configuration ensures that fiducials are present across multiple Z-planes, thereby improving registration accuracy in three-dimensional imaging. In embodiments, the particles are arranged in an ordered manner. Ordered arrangements may be achieved, for example, by patterning wells, grooves, or chemical binding sites on the support surface, such that particles settle into predetermined positions. Such ordered arrays provide highly regular fiducial spacing, which can simplify registration algorithms and facilitate correction of both local and global distortions. In embodiments, the particles are sufficiently dense such that at least one particle is present in each registration subimage (e.g., each 320×320 pixel region). In certain aspects, the density is selected to ensure a minimum of three particles per subimage, thereby providing robust data for local alignment calculations. In other embodiments, the particles are deposited at lower density to reduce potential overlap with biological signals, with interpolation methods used to fill in regions lacking direct fiducials. In further embodiments, the particles are monodisperse in size, for example having an average longest dimension of about 150 nm to about 1,000 nm, such that all fiducials produce comparable point spread functions. In certain embodiments, particles have an average size of about 350-500 nm, producing sharp, diffraction-limited spots that are readily localized by imaging software.

In embodiments, the solid support is placed on a sample stage of a microfluidic device. In embodiments, the sample stage is configured to move (e.g., translate along an axis). In embodiments, the speed of the sample stage moves at a rate of about 1 mm/second to about 50 mm/second. In embodiments, the speed of the sample stage moves at a rate of about 10 mm/second to about 30 mm/second. In embodiments, the speed of the sample stage moves at a rate of about 15 mm/second to about 25 mm/second. In embodiments, the speed of the sample stage moves at a rate of about 20 mm/second. The sample stage is configured to receive or support a sample, for example a sample comprising a flow cell, reaction vessel, or other substrate wherein the flow cell, reaction vessel, or other substrate includes one or more objects to be imaged (e.g., biomolecules). The sample stage is configured to move along any of x/y/z axes, which are oriented and/or aligned relative to the sample stage. In embodiments, the sample stage includes a precision mounting plate. A precision mounting plate may be fabricated with alignment surfaces, such as mounting pins, grooves, slots, grommets, tabs, magnets, datum surfaces, tooling balls, or other surfaces designed to accept subassemblies or modules of interest. In embodiments, the sample stage is a motorized translation stage. In embodiments, the motor is a stepper motor, piezo motor, brushless motor, hysteresis motor, linear motor, or a servomotor. In embodiments, the motor is a stepper motor. In embodiments, the stepper motor includes an integrated ball spline. In embodiments, the motor is a piezo motor. In embodiments, the motor is a brushless motor. In embodiments, the motor is a hysteresis motor. In embodiments, the motor is a linear motor. In embodiments, the motor is a servomotor. In embodiments, the servomotor includes a braking mechanism. In embodiments, the motor is a Picomotor™ actuator. In embodiments, the sample stage is configured to receive and retain a sample. In embodiments, the sample stage is configured to receive and retain a reaction vessel containing a sample (e.g., a flow cell as described herein). In embodiments, the sample stage includes a position encoder, wherein the position encoder generates a synchronization signal that synchronizes the travel of the fluorescent emissions. In embodiments, the imaging system further includes an absolute encoder. An absolute encoder provides information about the position (i.e., the distance) the camera, the image sensor, and/or the lens, relative to the sample stage and/or the sample. The absolute position encoder not only provides highly repeatable positioning, but also enables the recovery of a previously-saved position if rescanning a previously imaged region.

In embodiments, the solid support includes an IR reflective coating. In embodiments, the IR reflective coating is attached to the solid support. In embodiments, the IR reflective coating is attached to the solid support, wherein the IR reflective coating is in contact with the polymer described herein. In embodiments, the IR reflective coating includes metal oxides. In embodiments, the IR reflective coating includes titanium dioxide, zinc oxide, tin oxide, tantalum pentoxide, silicon dioxide, indium tin oxide, silver-based coating, ceramic-based coating or a combination thereof. In embodiments, the IR reflective coating includes SiO₂, TiO₂, Al₂O₃ and Ta₂O₅ and fluorides such as MgF₂, LaF₃ and AlF₃. In embodiments, the IR reflective coating includes tantalum pentoxide (Ta₂O₅) and silicon dioxide (SiO₂). In embodiments, the infrared (IR) reflective coating includes one or more layers of silicon dioxide (SiO₂) and tantalum pentoxide (Ta₂O₅). In embodiments, the infrared (IR) reflective coating includes alternating layers of silicon dioxide (SiO₂) and tantalum pentoxide (Ta₂O₅), wherein the layer of silicon dioxide (SiO₂) is in direct or indirect contact with the polymer (e.g., the polymer described herein). In embodiments, the infrared (IR) reflective coating includes alternating layers of silicon dioxide (SiO₂) and tantalum pentoxide (Ta₂O₅), wherein the layer of tantalum pentoxide (Ta₂O₅) is in direct or indirect contact with the polymer (e.g., the polymer described herein).

In embodiments, the IR reflective coating reflects near-infrared radiation (NIR). In embodiments, the IR reflective coating reflects mid-or far-infrared radiation. In embodiments, the IR reflective coating reflects wavelengths greater than 750 nm. In embodiments, the IR reflective coating reflects wavelengths greater than 760 nm. In embodiments, the IR reflective coating reflects wavelengths greater than 770 nm. In embodiments, the IR reflective coating reflects wavelengths greater than 780 nm. In embodiments, the IR reflective coating reflects wavelengths greater than 790 nm. In embodiments, the IR reflective coating reflects wavelengths greater than 800 nm. In embodiments, the IR reflective coating reflects wavelengths from about 750 nm to 1,000 μm. In embodiments, the infrared (IR) reflective coating includes one or more layers of silicon dioxide (SiO₂) and tantalum pentoxide (Ta₂O₅). A multilayer configuration leverages the distinct optical properties of both materials to enhance the IR reflectivity. Silicon dioxide, known for its low refractive index, and tantalum pentoxide, recognized for its high refractive index, are alternately layered to create a stack that exhibits high reflectance in the infrared spectrum. The alternating layers of SiO₂ and Ta₂O₅ result in constructive interference of light at specific wavelengths, thereby enhancing the IR reflective capability of the coating. The number and thickness of these layers can be tailored to target specific wavelengths within the IR range, or permitting a certain percentage of radiation to transmit. For example, the IR reflective coating may reflect 2-3%, 2-6%, or 2 to 10% of the total IR radiation, and it absorbs or transmits the remaining IR radiation (e.g., greater than about 90% of the IR radiation). In embodiments, the IR reflective coating reflects about 1%, about 2%, about 3%, about 4%, about 5%, about 6%, about 7%, about 8%, about 9%, or about 10% of the total IR radiation.

### III. Methods

In an aspect is provided a method of mating a first slide to a second slide, the method including: positioning a drilled glass slide on a drilled glass slide section of a slide mating assembly; positioning a tissue slide on a tissue slide section of the slide mating assembly; and moving one of the drilled glass slide section relative to the other of the tissue slide section such that the drilled glass slide aligns in juxtaposition with the tissue slide. In embodiments, the slide mating assembly includes a receptacle. The receptacle may be any size or shape suitable for holding a flow cell to be assembled. For example, the receptacle may be circular in shape to hold a circular flow cell or rectangular in shape to hold a rectangular flow cell. The receptacle may also be roughly the same size as the flow cell. In some instances, the receptacle is between 6 and 9 cm (e.g., between 6.5 and 8.5 cm, between 6.75 and 8.25 cm, between 7 and 8 cm, between 7.25 and 7.75 cm, between 7.3 and 7.7 cm, between 7.4 and 7.6 cm, between 7.45 and 7.55 cm, between 6 and 8 cm, between 7 and 9 cm, between 6 and 7 cm, between 8 and 9 cm, between 6 and 7.5 cm, between 7.5 and 9 cm, about 6 cm, about 6.25 cm, about 6.5 cm, about 6.75 cm, about 7 cm, about 7.1 cm, about 7.2 cm, about 7.3 cm, about 7.4 cm, about 7.5 cm, about 7.6 cm, about 7.7 cm, about 7.8 cm, about 7.9 cm, about 8 cm, about 8.25 cm, about 8.5 cm, about 8.75 cm, or about 9 cm) in cross sectional dimension, e.g., diameter. In some instances, the receptacle is about 7.5 cm in cross sectional dimension, e.g., diameter. The receptacle may include a depression in which the bottom layer is disposed. Alternatively, the receptacle may be an area of the surface of the flow cell holder.

In embodiments, the glass slide section and the tissue slide section rotatably move relative to one another. In embodiments, the glass slide section and the tissue slide section are configured to rotatably move relative to one another. The rotational movement is facilitated by the hinge assembly, allowing the slide mating assembly to transition between the open state and the closed state. In embodiments, the hinge assembly may include one or more pivot points, such as pins, axles, or bearings, positioned to enable smooth and controlled rotation between the two sections. The range of rotational movement may be limited to a predefined angle, such as up to 180 degrees, to ensure proper alignment and functionality of the assembly while preventing overextension. In embodiments, the components of the hinge assembly are constructed from durable materials, such as metals or reinforced polymers, to withstand repeated rotational cycles without degradation. To enhance usability, the hinge mechanism may incorporate friction-reducing features or adjustable tension elements, ensuring that the glass slide section and tissue slide section can rotate smoothly while maintaining stability in both the open and closed positions. The rotatable movement ensures ease of access to the slides and facilitates precise alignment during operation. In embodiments, precise alignment refers to the ability of the slide mating assembly to position the tissue slide and drilled glass slide such that their respective features, such as channel geometries, adhesive regions, or capture sites, are brought into registered contact with minimal offset. For example, the assembly may be configured to maintain alignment within a tolerance of ±100 microns in the X and Y axes and ±1 degree in rotation about the Z axis. This level of precision ensures compatibility with microfluidic channel registration, optical imaging requirements, or reagent flow paths that rely on consistent slide-to-slide positioning. In embodiments, alignment tolerances may be maintained through a combination of hinge geometry, datum feature engagement, and mechanical stops that define the fully closed position.

In embodiments, the method further includes locking the slide mating assembly while the drilled glass slide is aligned in juxtaposition with the tissue slide. The locking mechanism ensures that the slide mating assembly remains securely in the closed state, maintaining alignment and preventing unintended movement during use or transport. In embodiments, the locking may be achieved through a lock assembly integrated into the hinge or positioned along the edges of the glass slide section and tissue slide section. The lock assembly may include components such as latches, clasps, or detents that engage when the slides are brought into alignment. In embodiments, the lock assembly may be manually operated or automatically engage when the assembly transitions into the closed state. The locking mechanism may be designed with release features, such as push buttons or sliding levers, to allow for smooth and easy disengagement when transitioning the assembly back to the open state. In alternative embodiments, the locking system may incorporate tactile or audible feedback, such as a click or snap, to confirm that the assembly is securely locked in place while ensuring the drilled glass slide and tissue slide remain in juxtaposition.

In embodiments, the method includes using a feature to align a respective slide with the glass slide section or the tissue slide section. The alignment feature ensures that the slides are positioned accurately and securely during operation, facilitating interaction between the drilled glass slide and the tissue slide. In embodiments, the alignment feature may include raised edges, grooves, or recessed channels on the upper surfaces of the glass slide section or tissue slide section. In embodiments, the features guide the slides into their correct positions and prevent misalignment during placement. The alignment feature may also include visual markers, such as visible lines (715) or dots, to assist in the precise positioning of the slides. In alternative embodiments, tactile features, such as corner exclusion pads (730) or upraised bumpers, may be used to provide physical boundaries for the slides, ensuring consistent alignment. The alignment feature may be dimensioned to correspond to the size and shape of the respective slides, with tolerances designed to allow a snug fit while enabling easy insertion and removal.

In embodiments, the method includes immobilizing a plurality of tissue sections to the first slide, wherein a tissue in a plurality of tissue sections includes the biomolecule to be detected. In embodiments, the method includes immobilizing 2 tissue sections (10 mm×17 mm sections). In embodiments, the method includes immobilizing 4 tissue sections (10 mm×17 mm sections). In embodiments, the method includes immobilizing 6 tissue sections (10 mm×17 mm sections). In embodiments, the method includes immobilizing 24 tissue sections (10 mm×17 mm sections). In embodiments, the method includes immobilizing 8 tissue sections (10 mm×10 mm sections). In embodiments, the method includes immobilizing 10 tissue sections (10 mm×10 mm sections). In embodiments, the method includes immobilizing 12 tissue sections (10 mm×10 mm sections). In embodiments, the method includes immobilizing 16 tissue sections (10 mm×10 mm sections). In embodiments, the method includes immobilizing 20 tissue sections (10 mm×10 mm sections). In embodiments, the method includes immobilizing 40 tissue sections (10 mm×10 mm sections). In embodiments, the method includes immobilizing 2 to 32 tissue sections (4.5 mm×4.5 mm sections). In embodiments, the method includes immobilizing 32 tissue sections (4.5 mm×4.5 mm sections). In embodiments, the method includes immobilizing 128 tissue sections (4.5 mm×4.5 mm sections).

The cell or tissue may be manipulated prior to immobilizing the cell or tissue onto a slide using known techniques in the art (see, e.g., PCT Publication WO2023076832A1). In embodiments, the method further includes cutting a sample portion from the biological sample (e.g., including cells or tissues) using a punch device such that the punch device contains the sample portion; mounting the punch device containing the sample portion onto the first slide as described herein (e.g., inverting the punch device); pushing the sample portion out of the punch device using a piston, so that all or a portion thereof of the sample portion is positioned on the first slide as described herein. In embodiments, the method further includes cutting a sample portion from the biological sample using two or more punch devices such that each punch device contains a different the sample portion; mounting each punch device containing the sample portion onto the first slide as described herein; pushing the sample portions out of the punch devices using one or more pistons so that the sample portions are positioned onto the first slide as described herein.

In an aspect, a method is provided for mating a first slide to a second slide using a slide mating assembly. The method includes positioning a drilled glass slide onto a first receiving surface of the assembly, the first receiving surface being formed in a first slide section. A tissue slide is positioned onto a second receiving surface formed in a second slide section. The first and second slide sections are coupled by a hinge, and the method further includes rotating one of the slide sections about the hinge to transition the assembly from an open configuration to a closed configuration. In the closed configuration, the drilled glass slide and the tissue slide are brought into juxtaposed alignment with one another (e.g., the opposing surfaces of the slides are placed in direct face-to-face contact with one another).

In embodiments, the method includes removing a liner from a pressure-sensitive adhesive disposed on the drilled glass slide prior to closure of the slide mating assembly. The liner may comprise a polymeric film or coated paper material that temporarily covers the adhesive to prevent premature contact or contamination. Removal of the liner exposes the adhesive surface, enabling bonding between the drilled glass slide and the tissue slide when the assembly is closed.

In embodiments, the method includes actuating a locking mechanism to secure the slide mating assembly in a closed configuration. The locking mechanism may include a manually operated lever or latch that transitions between open and closed states, thereby applying a retaining force that maintains the relative position of the slide sections. In certain embodiments, actuation of the locking mechanism ensures consistent pressure across the mated slides, supporting proper adhesive engagement and preventing unintended separation during handling or processing.

In embodiments, the method includes using an alignment feature on at least one of the receiving surfaces to constrain placement of a respective slide. The alignment feature may include one or more physical structures such as dowel pins, posts, chamfered corners, recessed contours, or laser-engraved outlines that interface with corresponding features of the slide. These structures provide positional constraint by limiting degrees of freedom in translation and rotation, thereby guiding the slide into a repeatable and correct orientation. In certain embodiments, the alignment features are dimensioned to maintain placement tolerance within 100 microns or less.

In embodiments, the slide mating assembly includes an interlock feature configured to prevent closure of the assembly unless a locking assembly on the tissue slide section is engaged. The interlock feature may include a mechanical stop, tab, latch, or pin that obstructs the rotational movement of the glass slide section until the tissue slide section is in a locked state. In some embodiments, the interlock is achieved through physical interference between components that retract or disengage only when the lock lever or mechanism on the tissue slide section is actuated. This ensures that the user cannot initiate the mating process unless both slides are properly secured, thereby reducing the risk of slide misalignment, damage, or partial bonding. The interlock feature may be passive or active, and may be integrated with the existing locking components or provided as a separate mechanism.

In embodiments, the method includes obtaining an image of the tissue sample. The imaging step may be performed with high-resolution techniques, such as fluorescence microscopy, which captures emitted signals from fluorescent particles introduced to specific surfaces of the tissue sample. In embodiments, and to ensure comprehensive visualization, images may be taken across multiple focal planes or cross-sections along the z-axis of the tissue, capturing features at various depths to enable identification of key structures and interfaces. Imaging parameters, including exposure time, gain settings, and focal depth, may be adjusted to optimize contrast and resolution, contributing to the clarity and precision of each acquired image. Obtaining detailed images allows for accurate localization of fluorescent particles relative to the tissue layers and supports subsequent computational analyses. These analyses may include edge detection via the Laplacian operator and variance calculations, instrumental in distinguishing boundaries and measuring distances within the tissue. The imaging process thereby provides a critical foundation for assessing the structural integrity, thickness, and spatial relationships among regions of interest within the tissue sample.

In another aspect is provided a method of making a flow cell assembly. In embodiments, the method includes binding a first slide and a second slide together, wherein the first slide or the second slide includes an inlet port. In embodiments, the first slide includes a polymer, a coupling agent, and/or a tissue. In embodiments, the second slide include an adhesive. In embodiments, the second slide is configured to define a reaction chamber when attached to the first slide.

In embodiments, affixing the second slide to the first slide includes applying pressure to create a fluidic leak-free seal between the first and second slides. In embodiments, applying pressure forms a bond between the gasket and the first and second slides. In embodiments, affixing the second slide to the first slide includes using a UV curable adhesive attached to the second slide, where the UV curable adhesive is cured when exposed to wavelengths between 365 nm to 380 nm. In embodiments, affixing the second slide to the first slide includes using a UV curable adhesive attached to the second slide, where the UV curable adhesive is cured when exposed to wavelengths between 380 nm to 405 nm. In embodiments, affixing the second slide to the first slide includes using a UV curable adhesive attached to the second slide, where the UV curable adhesive is cured when exposed to wavelength of 405 nm.

In embodiments, the UV-curing adhesive cures when exposed to UV light for about 1 minute, about 5 minutes, about 10 minutes, about 15 minutes, about 20 minutes, about 25 minutes, about 30 minutes, about 40 minutes, about 50 minutes, about 60 minutes, about 70 minutes, about 80 minutes, about 90 minutes, or about 100 minutes. In embodiments, the UV-curing adhesive cures when exposed to UV light for about 10 minutes. In embodiments, the UV-curing adhesive cures when exposed to UV light for about 15 minutes. In embodiments, the UV-curing adhesive cures when exposed to UV light for about 20 minutes. In embodiments, the UV-curing adhesive cures when exposed to UV light for about 30 minutes.

In embodiments, affixing the second slide to the first slide includes using a spacer element. In embodiments, the spacer element includes an adhesive. In embodiments, the spacer element includes a pressure sensitive adhesive (PSA) attached to the second slide, where the pressure sensitive adhesive is affixed with the application of pressure of about 5 psi, 6 psi, 7 psi, 8 psi, 9 psi, 10 psi, 11 psi, 12 psi, 13 psi, 14 psi, 15 psi, 16 psi, 17 psi, 18 psi, 19 psi, 20 psi, or more. In embodiments, the spacer element includes a pressure sensitive adhesive (PSA) attached to the second slide, where the pressure sensitive adhesive is affixed with the application of pressure of about 20 psi, 21 psi, 22 psi, 23 psi, 24 psi, 25 psi, 26 psi, 27 psi, 28 psi, 29 psi, 30 psi, 31 psi, 32 psi, 33 psi, 34 psi, 35 psi, 36 psi, 37 psi, 38 psi, 39 psi, 40 psi, 41 psi, 42 psi, 43 psi, 44 psi, 45 psi, 46 psi, 47 psi, 48 psi, 49 psi, 50 psi, 51 psi, 52 psi, 53 psi, 54 psi, 55 psi, 56 psi, 57 psi, 58 psi, 59 psi, 60 psi, 61 psi, 62 psi, 63 psi, 64 psi, 65 psi, 66 psi, 67 psi, 68 psi, 69 psi, 70 psi, 71 psi, 72 psi, 73 psi, 74 psi, 75 psi, 76 psi, 77 psi, 78 psi, 79 psi, 80 psi, 81 psi, 82 psi, 83 psi, 84 psi, 85 psi, 86 psi, 87 psi, 88 psi, 89 psi, 90 psi, 91 psi, 92 psi, 93 psi, 94 psi, 95 psi, 96 psi, 97 psi, 98 psi, 99 psi, 100 psi, or more. In embodiments, the spacer element includes a pressure sensitive adhesive (PSA) attached to the second slide, where the pressure sensitive adhesive is affixed with the application of pressure between about 10-15 psi. In embodiments, the spacer element includes a pressure sensitive adhesive (PSA) attached to the second slide, where the pressure sensitive adhesive is affixed with the application of pressure between about 10-20 psi. In embodiments, the spacer element includes a pressure sensitive adhesive (PSA) attached to the second slide, where the pressure sensitive adhesive is affixed with the application of pressure of about 10 psi. In embodiments, the spacer element includes a pressure sensitive adhesive (PSA) attached to the second slide, where the pressure sensitive adhesive is affixed with the application of pressure of about 15 psi. In embodiments, the spacer element includes a pressure sensitive adhesive (PSA) attached to the second slide, where the pressure sensitive adhesive is affixed with the application of pressure of about 20 psi. In embodiments, the spacer element includes a pressure sensitive adhesive (PSA) attached to the second slide, where the pressure sensitive adhesive is affixed with the application of pressure of about 25 psi. In embodiments, the spacer element includes a pressure sensitive adhesive (PSA) attached to the second slide, where the pressure sensitive adhesive is affixed with the application of pressure of about 30 psi. In embodiments, affixing includes heating the assembly (e.g., heating to 40, 50, 60, or 70° C.).

In embodiments, affixing the second slide to the first slide placing the first slide described herein and the second slide described herein and applying uniform pressure. The pressure ensures consistent contact across the surfaces, preventing gaps or irregularities in the reaction chamber. The uniform pressure may be applied using a mechanical press, weights, or rollers, depending on the precision required for the assembly.

In embodiments, the method includes attaching the first slide and a second slide with a gasket between the first slide and the second slide wherein the gasket is double-sided tape. In embodiments, the method includes attaching the first slide and a second slide with a double-sided tape between the first slide and the second slide, wherein the first slide includes drilled ports. In embodiments, the method includes attaching the first slide and a second slide with a double-sided tape between the first slide and the second slide, wherein the second slide includes drilled ports.

In an aspect is provided a method of securing a glass slide in in an assembly as described herein. In embodiments, the method includes placing the slide on the at least one platen, aligning the slide with the plurality of magnets and pins, wherein the securing is configured to constrain six degrees of freedom of the flow cell carrier. In embodiments, the securing does not require any additional fixation mechanism (e.g., clamps, clips, screws, latches, knobs, buttons, or grooves), beyond the magnet described herein. In embodiments, the plurality of magnets are oriented to complete a magnetic field loop with constructive interference.

### EXAMPLES

### Example 1. Tack Tool Design

In laboratory and diagnostic applications, the formation of a reliable flow cell is critical for conducting controlled biological reactions and imaging processes. A flow cell typically comprises two precisely aligned glass slides, for example using a functionalized planar slide that retains biological specimens and a complementary slide configured to define a reaction channel, complete with ports for the introduction and removal of fluids. Flow cells are integral components in next-generation sequencing (NGS) technologies, serving as sophisticated platforms for DNA sequencing. At their core, a flow cell is a hollow glass slide with one or more channels (“lanes”), through which reagents and solutions (e.g., polymerases, nucleotides, and buffers) may traverse. A surface within the channel includes a plurality of immobilized oligonucleotides for capturing target nucleic acid fragments of interest. The captured target molecules may then be amplified and sequenced. While flow cells have been instrumental in transforming the efficiency and economic feasibility of NGS, their application in spatial biology, particularly for in situ transcript detection within cells and tissues, remains unexplored and challenging. A primary impediment in this translation is tissue delamination, a process where the structural integrity of tissue samples is compromised during repetitive reagent exchanges and thermal changes. Furthermore, when utilizing tissue sections, commonly around 5-7 μm in thickness, additional complications arise.

Traditional methods for mating these slides, however, pose significant challenges. Misalignment can lead to inconsistent flow dynamics and compromised imaging quality, while improper sealing may result in fluid leaks, jeopardizing sample integrity and experimental outcomes. Furthermore, the fragile nature of glass increases the risk of chipping or breakage during assembly, particularly when high precision (i.e., within a tolerance of 100 microns) is required to ensure proper flow cell function. Thus, there is a critical need for a device that can securely mate these two slides, providing active alignment, a foolproof assembly process, and protection against damage, thereby enabling reliable, high-quality flow cell formation for a wide range of scientific and diagnostic applications.

To address the challenges associated with creating a stable and reliable flow cell, described herein is a device that enables precise, damage-free mating of two glass slides. In embodiments, the first slide is a functionalized planar surface designed to retain biological specimens, providing a stable substrate for experimental manipulation. The second slide defines a reaction channel with integrated ports for the introduction and removal of fluids, enabling controlled fluid dynamics essential for various biological assays and imaging workflows. Together, these slides form a flow cell that must maintain structural integrity, fluid containment, and precise alignment.

The device incorporates an active alignment system that achieves a tolerance of 100 microns or less, essential for maintaining the integrity of the flow cell. Precision alignment is facilitated by adjustable hinge alignment and sliding alignment pins that guide each slide into position, ensuring consistent alignment over repeated uses. Calibration of these alignment features is performed at the factory to maintain long-term reliability, addressing the requirement for precise positioning within the tolerance range.

The design of the alignment mechanism prioritizes protection of the slides'edges, which are particularly susceptible to chipping. By confining the alignment features within the thickness of the glass (e.g., 0.7 mm), the device minimizes the risk of damage while still providing the necessary structural support for accurate alignment. The flat, planar support surface ensures that each slide is securely supported during assembly, preventing breakage and meeting the requirement for structural integrity without compromising glass safety.

To ensure correct installation of both slides, the device includes a Poke-Yoke feature, implemented via a dowel pin positioned at the chamfer corner. This installation safeguard helps the user orient and position each slide accurately, preventing misalignment or improper orientation. This feature is particularly valuable in preventing user error, thereby enhancing the reliability of the device in laboratory settings where rapid and accurate setup is often required.

Once the slides are properly aligned and in place, a locking mechanism secures the device in a closed position. This lock serves not only to prevent accidental opening but also to maintain the internal structure of the flow cell, ensuring that the slides remain in precise alignment throughout the experimental process. The locking mechanism also includes a spring-actuated tab, which provides clear indicators for ‘Open’ and ‘Closed’ states via a two-position lever engraved with symbols. Such indicators are particularly beneficial in complex laboratory workflows, where visual cues can help prevent incomplete closures that might lead to fluid leakage or sample loss.

In applications involving fluid introduction and removal, such as on the G4X™ Spatial Sequencing instrument, maintaining a leak-proof seal is critical. The device's design facilitates bonding and alignment for two independent slides, and creates a secure seal around the reaction channel, preventing any unwanted fluid escape within neighboring channels. The sealing mechanism is supported by the alignment and locking features, which work together to apply consistent pressure across the slides, ensuring that fluid is contained within the reaction channel even under varying flow conditions. Following mating, the slides may be further processed, for example my exposing the adhesive to UV light, applying pressure (e.g., pressing the two slides together), modulating the temperature, or a combination thereof.

To further enhance the device's usability, an optional damper may be integrated into the closure mechanism. This damper mitigates the risk of accidental slamming during closure, which could otherwise damage the fragile glass slides. By absorbing impact, this damper would make the device more resilient to handling errors, particularly in high-throughput environments.

In embodiments, the device enables secure, precise, and user-friendly assembly of a flow cell composed of two specialized glass slides. Through its combination of alignment accuracy, user guidance features, secure locking, and optional impact protection, the device addresses critical challenges in flow cell assembly. This solution not only minimizes the risk of damage to delicate glass slides but also ensures a stable, leak-proof environment for biological assays, offering an efficient and reliable tool for laboratory workflows.

### Example 2. Mating Two Slides

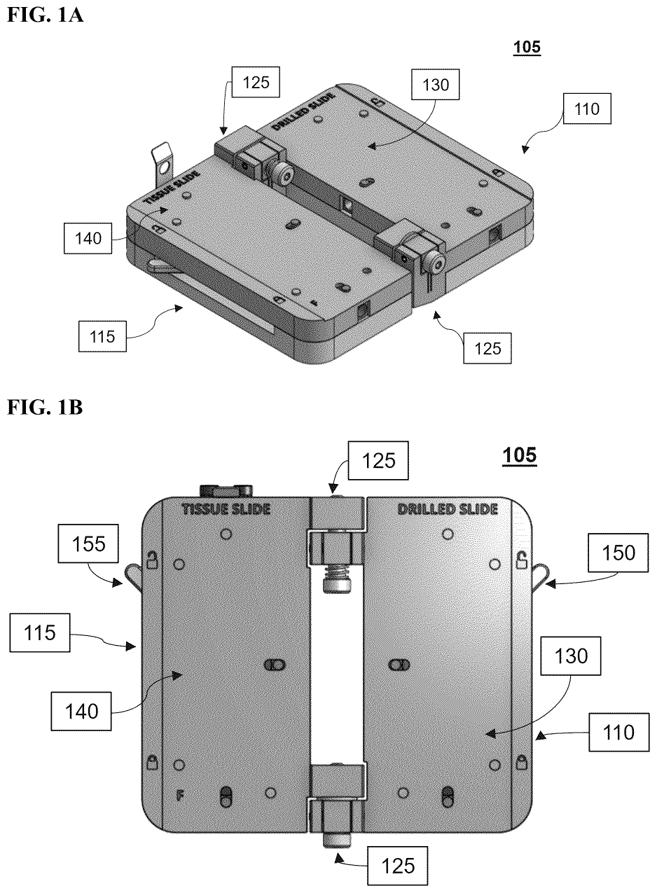

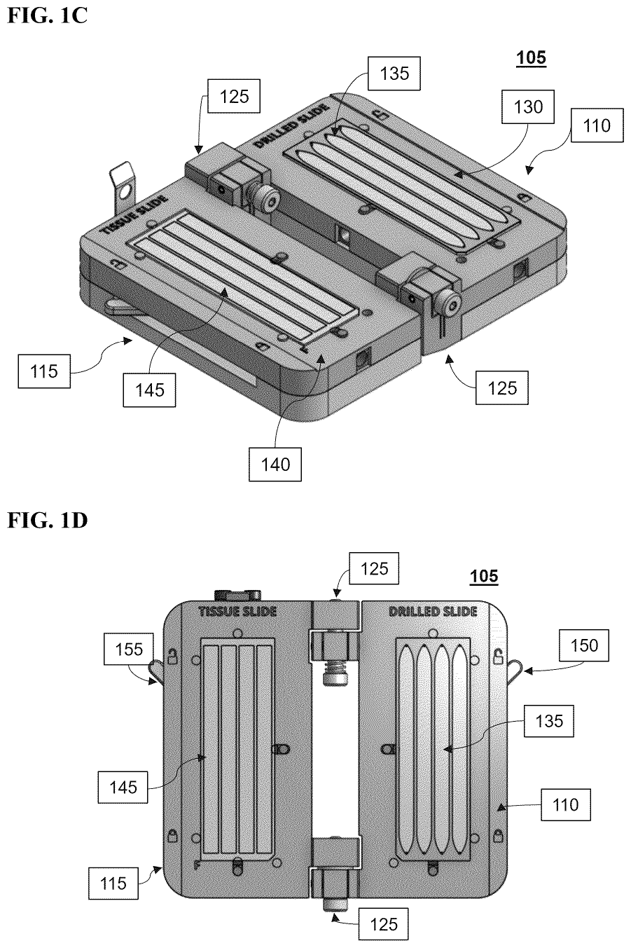

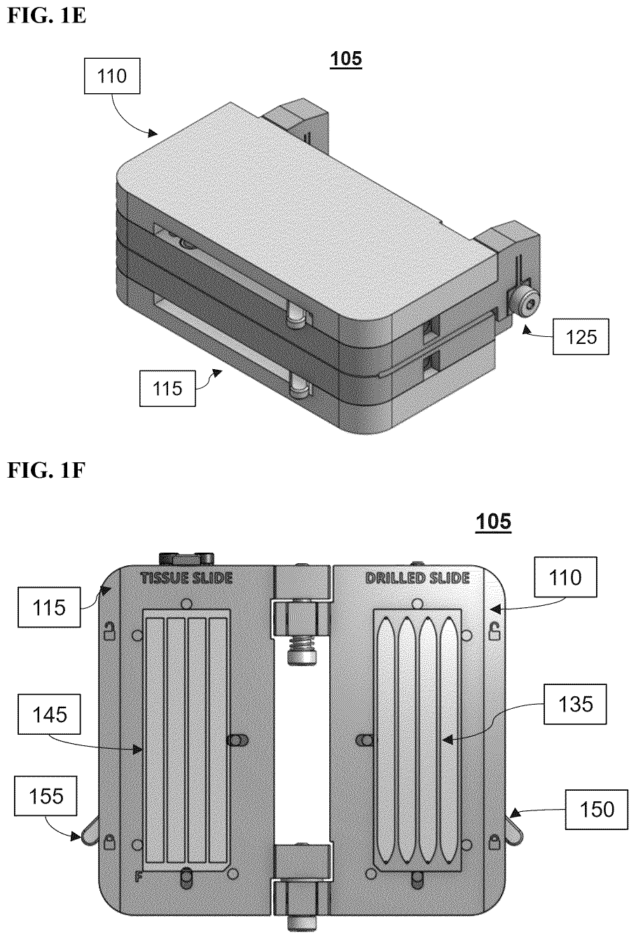

FIGS. 1A and 1B show a slide mating assembly or a slide assembly fixture 105 includes a Drilled Glass Slide section 110 and a Tissue Slide section 115 that are movably coupled to one another via a hinge assembly 125. The hinge assembly 125 rotatably attaches the Drilled Glass Slide section 110 and a Tissue Slide section 115 such that the Drilled Glass Slide section 110 and a Tissue Slide section 115 can open and close in “clamshell” or folding configuration similar to closing a book. The Drilled Glass Slide section 110 has an upper surface 130 that defines a seat sized and shaped to receive a drilled glass slide 135 (FIGS. 1C and 1D) as described further below. The Tissue Slide section 115 likewise has an upper surface 140 that defines a seat sized and shaped to receive a tissue slide 145 (FIGS. 1C and 1D) as described further below. FIGS. 1C and 1D show the drilled glass slide 135 and tissue slide 145 positioned on the Drilled Glass Slide section 110 and the Tissue Slide section 115, respectively. The Drilled Glass Slide section 110 and the Tissue Slide section 115 can each be a prismatic body or structure that has a rectangular shape when viewed from the top although the shape can vary.

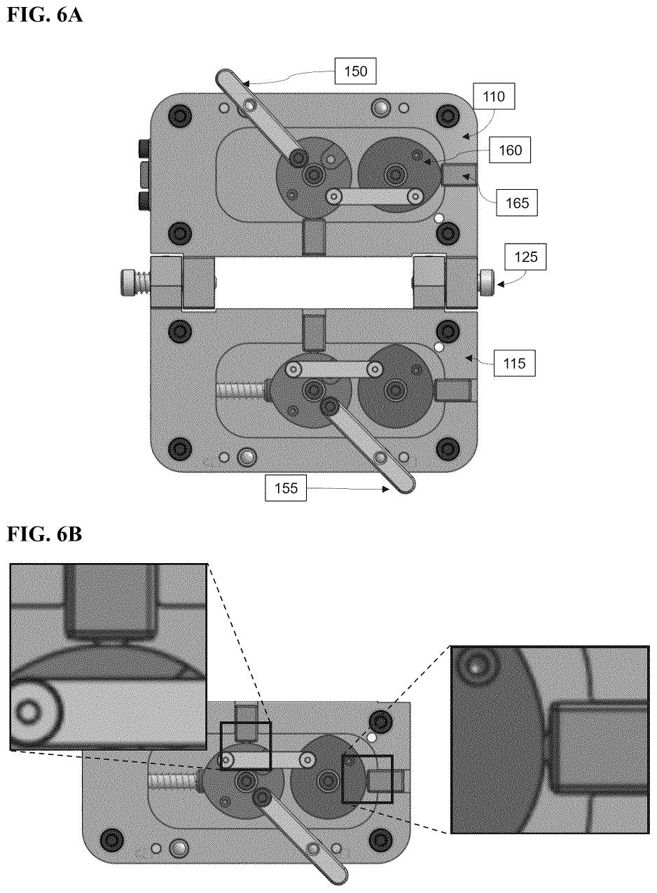

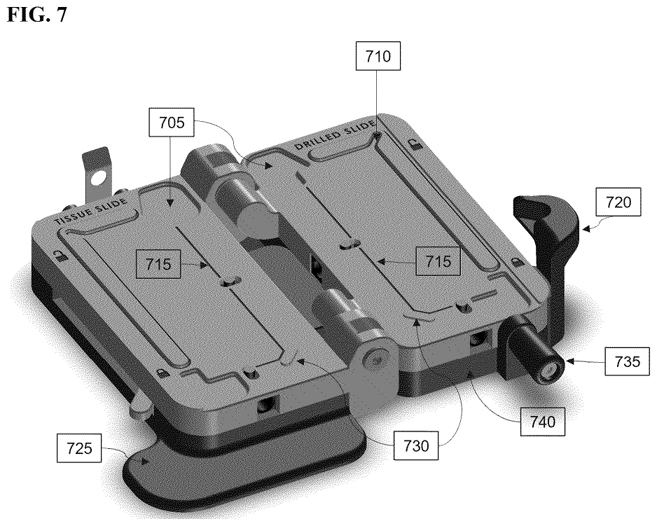

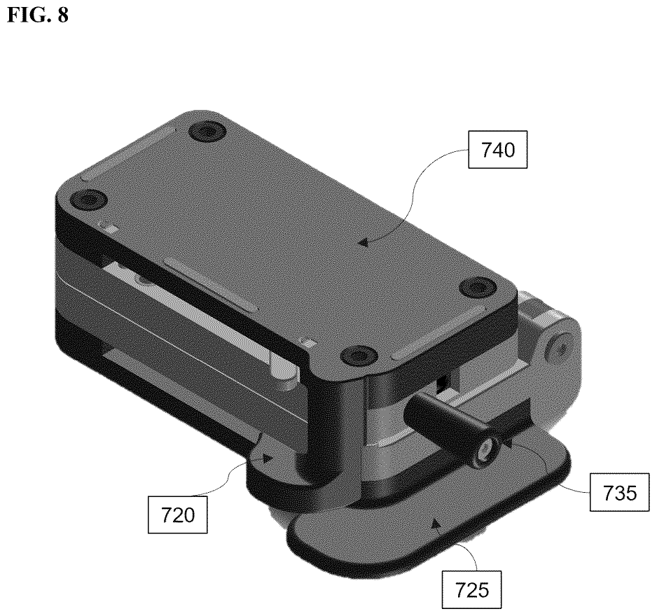

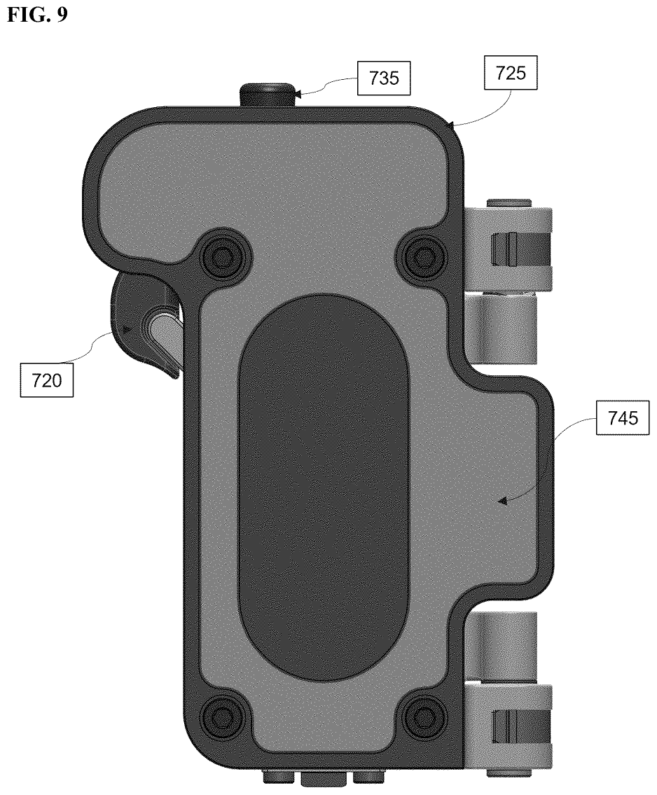

With reference to FIG. 1B and FIG. 6A, the Drilled Glass Slide section 110 has a glass slide lock assembly with an actuator, such as a lever 150, that can be actuated to lock the drilled glass slide 135 onto the Drilled Glass Slide section 110. Similarly, the Tissue Slide section 115 features a tissue slide lock assembly with an actuator, such as a lever 150, that locks the tissue slide 145 onto the Tissue Slide section 115, as described further below. A magnetic “spring” force is implemented to ensure positive pressure against the slide edges for precise positioning against datum features. Thus, the magnets of the sliders create a magnetic field exerting a downward force on the slide, aiding in retaining the slide on the platen. Magnets, as used herein, includes ferromagnetic, paramagnetic, and superparamagnetic materials. Note that a magnetic entity need not be formed entirely of a magnetic material but may instead comprise both magnetic and nonmagnetic materials. Typically a magnet will contain a magnetic or magnetizable material such as iron, cobalt, nickel, or certain ceramics. It should be appreciated that the quantity and positioning of the magnets (or other constraining component) can vary to achieve any of a wide variety of constraint configurations.

FIG. 6B illustrates the locking mechanism, highlighting a controlled gap (e.g., 1 mm or less) between sliders 165 and cams 160 in the locked position. This gap generates the magnetic spring force via magnets embedded in the sliders 165, which interact with the x-clamp pin 126 and the y-clamp pin 127 to secure and retain the slides. The amount of pull force may be tuned by varying the distance between the slider and the cam. For example, the pull force may be about 2.5 pound-force to about 0.1 pound force, when varying the distance from 0 mm to 3.175 mm. The cams 160 are comprised of any suitable, durable material, for example ferrous material. The cams may be oriented in a manner to enable the x-clamp pin to engage with the slide at a different time than the y-clamp pin.

To assemble the flow cell, the slide assembly fixture 105 is positioned into the open position as shown in FIG. 1A and FIG. 1B. In the open position or open state, the upper surfaces of the Drilled Glass Slide section 110 and the Tissue Slide section 115 can both be facing upward and/or can be co-planar. As mentioned, the fixture 105 designates the “Drilled Glass Slide” section 110 on the right and the “Tissue Slide” section 115 on the left. Both sides of the fixture 105 are opened by adjusting the levers 150 and 155 to an open padlock position.

With the fixture prepared, the drilled glass slide 130 is inserted into its designated area on the right (“Drilled Glass Slide” section 110), as shown in FIGS. 1C and 1D. A chamfered edge of the drilled slide 130 aligns with a pin located in the bottom-right corner (or other location). The drilled glass slide 135 includes a top liner that temporarily protects the adhesive. Once positioned, the drilled glass slide 135 is secured by moving the lever to a locked padlock setting. Next, the tissue slide 145 is placed into the left side of the fixture (the “Tissue Slide” section 115), ensuring that the mounted tissue faces upward. A marker, such as a faintly engraved “F,” on the tissue slide aligns with a corresponding “F” marking on the fixture 105. After confirming placement, the tissue slide 145 is secured to the “Tissue Slide” section 115 by adjusting the lever 155 to the locked position. FIG. 1F shows the levers 150 and 155 in the locked position.

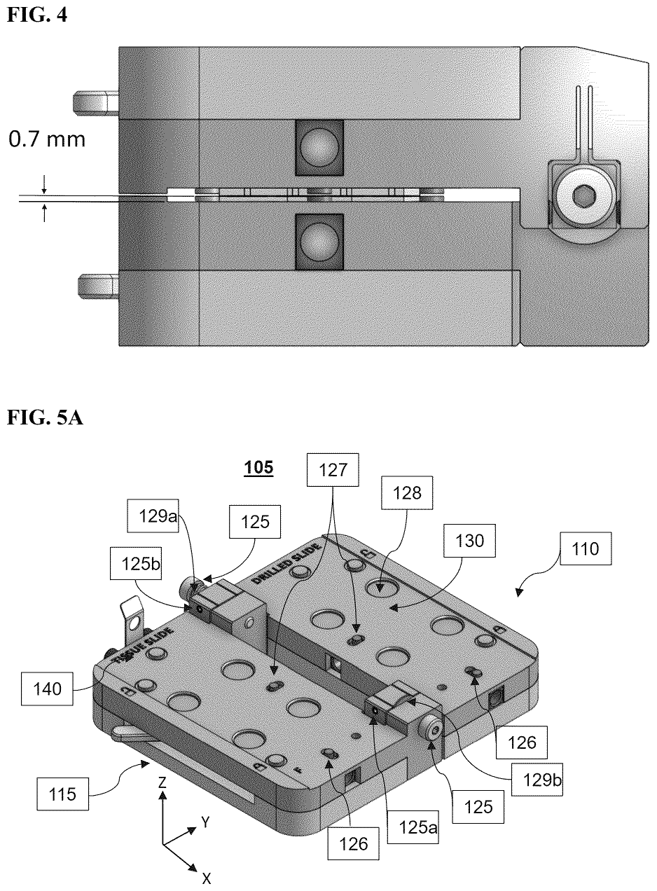

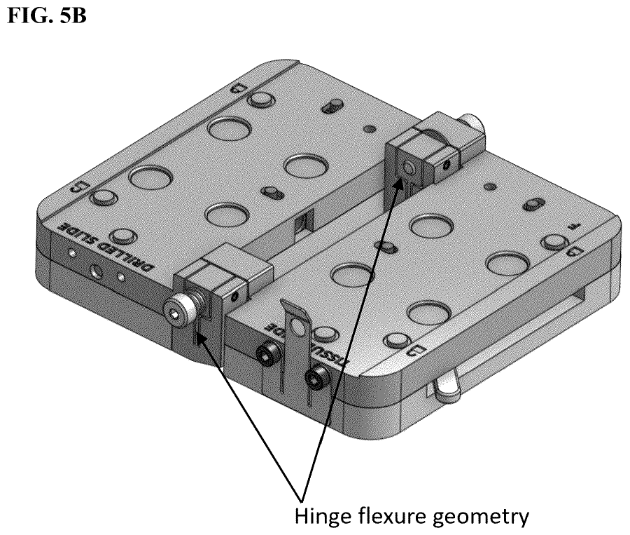

Precision alignment of the hinged assembly is achieved through a combination of axial shims and adjustable flexures. FIG. 5 depicts the glass slide mating assembly, which includes the Drilled Glass Slide section 110 and the Tissue Slide section 115 movably coupled via a hinge assembly 125. Set screws 125a and 125b allow for fine Y-axis adjustments and rotational alignment around the Z-axis, which is facilitated by hinge flexures integrated into the Drilled Slide hinges. The spring 129a and shim 129b enable x-axis adjustment and refining, taking advantage of the hinge flexure geometry (FIG. 5B).

With both the drilled glass slide 135 and the tissue slide 145 secured to the slide assembly fixture 105, the liner is removed from the pressure-sensitive adhesive (PSA) on the drilled glass slide 135. Following this, the drilled glass slide 135 is rotated, pivoted, or otherwise moved over the tissue slide 145 in a clamshell manner such that the upper surfaces of the Drilled Glass Slide section 110 and the Tissue Slide section 115 are in juxtaposed contact. This closes the slide assembly fixture 105, bringing the two slides 135 and 145 into alignment. FIG. 1E illustrates the fixture in the closed state. During this motion, cam profiles precisely guide the engagement of the datum features, with the long-axis datum features engaging first, followed by the short-axis datum features. This is controlled via the x-clamp pin 126 and the y-clamp pin 127, ensuring proper alignment before full engagement. In embodiments, a cam retention system includes a plastic cap configured to secure a cam in place without the use of a screw or washer. The plastic cap may be press-fit, snap-fit, or interference-fit into a corresponding recess in the slide mating assembly, applying a retaining force sufficient to hold the cam in position during normal operation. In some embodiments, the cap includes integrated locking tabs or radial features that engage with the surrounding structure to resist loosening due to vibration or repeated actuation.

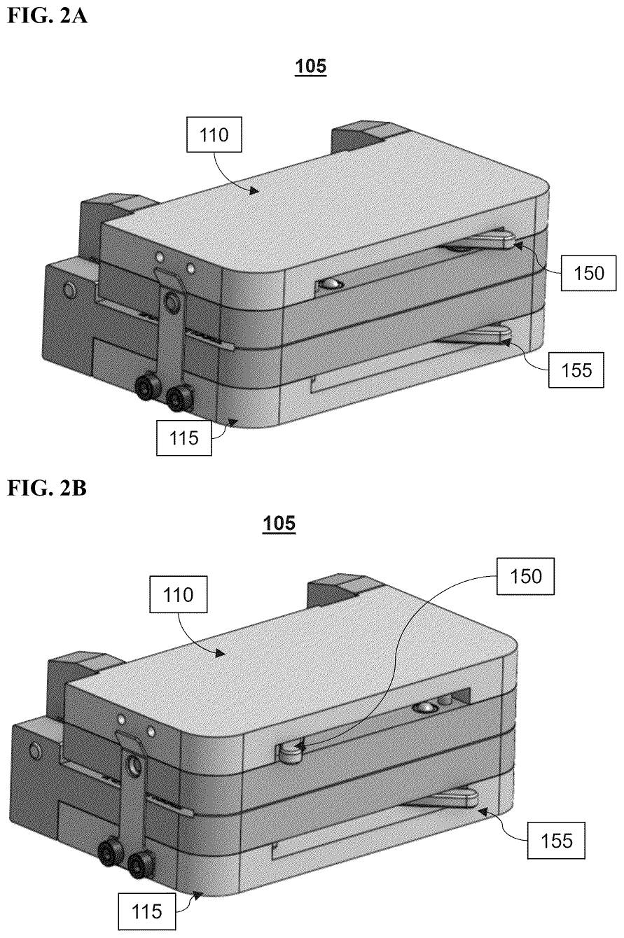

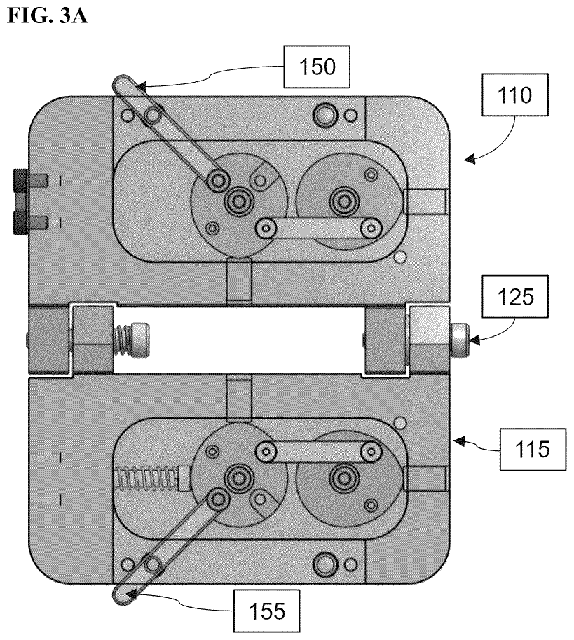

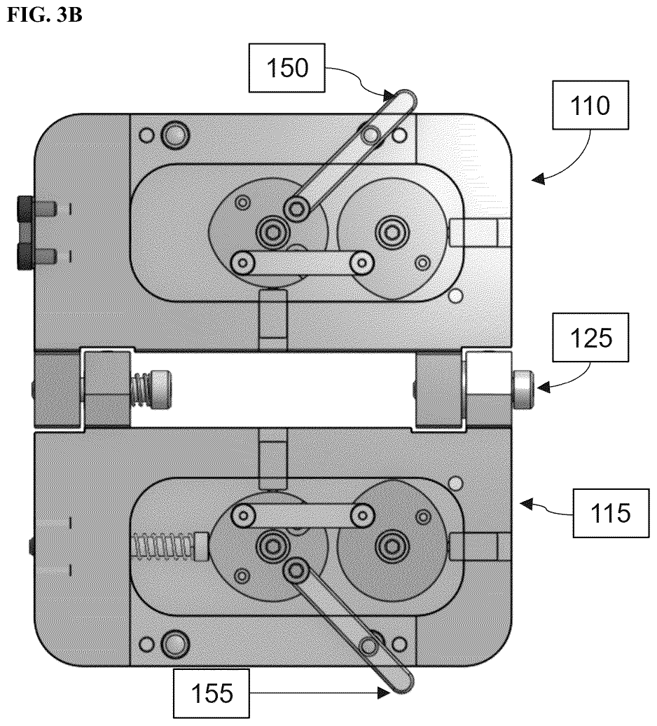

When the latches 150 and/or 155 are engaged, as shown in FIG. 2A, the hinge assembly 125 is prevented from opening. In embodiments, only latch 150 prevents opening; in others, only latch 155 prevents opening. This safety feature helps protect the user from accidental slide breakage. To release the assembly, the lever 150 on the Drilled Glass Slide section 110 is moved to the open padlock position, as shown in FIG. 2B, unlocking the fixture. The fixture is then opened, and the tissue slide lever 155 is adjusted to the open position, enabling the removal of the completed flow cell. The mechanism for locking via the levers 150 and 155 is detailed in FIGS. 3A and 3B.

What is claimed is:

1. A slide mating assembly, comprising:
a first slide section comprising a receiving surface configured to retain a drilled glass slide;
a second slide section comprising a receiving surface configured to retain a tissue slide;
a hinge assembly movably coupling the first slide section to the second slide section such that the assembly transitions between an open configuration and a closed configuration, wherein in the closed configuration, the receiving surfaces of the first and second slide sections are in juxtaposed contact;
at least one locking assembly configured to selectively retain the first slide and/or the second slide mating in the open configuration or the closed configuration; and
one or more magnetic elements configured to exert a downward spring force on a slide, the magnetic elements interacting with clamp pins to retain the slide in position during closure, wherein the magnetic spring force is adjustable based on a gap distance between a slider and a cam, wherein a pull force is tunable between about 0.1 and 2.5 pound-force.

2. The slide mating assembly of claim 1, wherein at least one locking assembly comprises a lever configured to transition the locking assembly between a locked state and an unlocked state.

3. The slide mating assembly of claim 1, wherein at least one locking assembly comprises: a first locking assembly positioned on the first slide section; and a second locking assembly positioned on the second slide section.

4. The slide mating assembly of claim 1, wherein the hinge assembly enables clamshell-style rotation such that the first slide section folds over the second slide section.

5. The slide mating assembly of claim 1, further comprising at least one alignment feature on the receiving surface of at least one of the slide sections, the alignment feature configured to constrain placement of a respective slide.

6. The slide mating assembly of claim 5, wherein the alignment feature comprises a dowel pin positioned to interface with a chamfered edge of the respective slide.

7. The slide mating assembly of claim 1, wherein the receiving surface comprises a finger well formed as an indentation.

8. The slide mating assembly of claim 1, wherein at least one of the slide sections comprises a moat configured to trap and/or drain particulate debris.

9. The slide mating assembly of claim 1, wherein at least one of the receiving surfaces comprises a visible marking indicating the correct orientation of a slide.

10. The slide mating assembly of claim 1, wherein the hinge assembly comprises a cam mechanism configured to engage long-axis datum features before engaging short-axis datum features during closure.

11. The slide mating assembly of claim 1, further comprising one or more adjustable flexures and axial shims configured to provide positional control along X, Y, or Z axes during alignment.

12. The slide mating assembly of claim 1, wherein the locking assembly includes an indicator lever comprising engraved open and closed symbols to visually convey latch status.

13. The slide mating assembly of claim 1, further comprising a damping element configured to absorb kinetic energy during closure to reduce impact on the slides.

14. The slide mating assembly of claim 1, further comprising a handle affixed to one of the slide sections, the handle including a rotatable portion that rotates in response to movement of the slide mating assembly between the open and closed configurations.

15. The slide mating assembly of claim 1, wherein at least one of the receiving surfaces comprises a black anodized coating and includes laser-engraved markings outlining slide alignment features.

16. The slide mating assembly of claim 1, further comprising an interlock feature configured to prevent closure of the slide mating assembly unless a locking assembly on the tissue slide section is engaged.

17. The slide mating assembly of claim 1, further comprising a serialization marking disposed on the base of the assembly, the serialization marking identifying a unique identifier associated with the assembly.

18. The slide mating assembly of claim 1, wherein a locking mechanism comprises a two-piece lock pin configured to reduce part count while maintaining retention function.

19. The slide mating assembly of claim 1, wherein the first slide and/or the second slide comprises an IR reflective coating.
